(19) United States
(12) Patent Application Publication
(10) Pub. No.: US 2016/0034437 A1
(43) Pub. Date: Feb. 4, 2016

(54) MOBILE SOCIAL CONTENT-CREATION APPLICATION AND INTEGRATED WEBSITE

(71) Applicants: Kim YONG, Redondo Beach,, CA (US); Philip LIANG, Redondo Beach, CA (US)

(72) Inventors: Kim YONG, Redondo Beach, CA (US); Philip LIANG, Redondo Beach, CA (US)

(21) Appl. No.: 14/777,227

(22) PCT Filed: Mar. 17, 2014
(86) PCT No.: PCT/US2014/030469

§ 371 Date: Sep. 15, 2015

Related U.S. Application Data
(60) Provisional application No. 61/794,052, filed on Mar. 15, 2013.

(51) Int. Cl. G06F 17/24; G06T 11/60; G06F 3/0484; G06F 17/22; G06F 3/0481

(52) U.S. Cl. CPC G06F 17/24; G06F 17/2247; G06F 3/04817; G06F 17/2235; G06F 3/04845; G06T 11/60

(57) ABSTRACT

A mobile device software application and interrelated mobile device-optimized website social user gallery is described. The application and website introduce 1) a new visual layout for images, text, and banners organized by topic, and optionally by date and relative order, 2) new mobile software user interfaces for viewing, creating, emailing, publicly displaying in a mobile website user gallery, partner linking, notifying via alarms, topic updating, and structurally organizing via text definition files and a local, on-device client database, these new visual layouts to empower users to create new content, or repurpose existing content from different topics, 3) new mobile software application client-side software framework marketing mechanisms, configurations, and specifications, 4) interrelated new mobile-optimized website social user gallery to display the publicly shared content sent by registered users from the mobile device software application.

### CROSS-REFERENCE TO RELATED APPLICATION

The present application is a national filing in the U.S. Patent & Trademark Office of PCT/US2014/030469 filed Mar. 17, 2014, and claims benefit of priority to U.S. provisional patent application, Ser. No. 61/794,052, entitled ‘Mobile Social Content-Creation Application and Integrated Website,” filed on Mar. 15, 2013, both of which applications are incorporated herein in their entireties by this reference.

### TECHNICAL FIELD

The present disclosure relates generally to software application. In particular, the present disclosure relates to methods and systems for creation, delivery, and sharing of multimedia content.

### BACKGROUND

Technology and business customers are increasingly relying on their mobile devices to consume, deliver, and share digital content. However, existing platforms and solutions often are less than satisfactory. For example, existing solutions often involve the lack of effective, instant, recurring methods to engage valuable, trusted customers on their mobile devices, such as smartphones, with compelling text/image/audio/video/embedded webpage multi-dimensional promotions and stories. Mobile device software app platforms may not empower a novice user to create mobile-first optimized content without requiring extensive marketing, advertising, graphics design, web/app programming development/management skills or costs from numerous external parties. Graphics design, publishing, webpage creation, and multimedia audio/video/image content creation, organization, and publishing software often requires legacy personal computer use (not a smartphone) at a significantly higher recurring cost, with more complexity involving a steeper learning curve, and not well-suited for mobile, portable, instant use, and sharing.

Many digital media marketing and advertising content creation companies and services create static print marketing physical media that does not change dynamically. They may create non-mobile websites which appear poorly and non-visibly on a mobile device such as smartphone. Mobile webpages may also be very difficult to modify, due to a lack of, or difficulty with, content management systems, and may waste much of the available screen or display space with minimally useful or legible information. (Then, the result is low visitor engagement and traffic to these websites, which are often viewed on smaller mobile device screens. This makes it increasing difficulty to create new publishing formats and integrate external 3^{rd} party software widgets/APIs and advertising media on mobile device webpages. Website owner often spend additional time and money to acquire the skills and resources to be able to frequently update focused content to attract new visitors in a recurring fashion with promotions, stories, and rich media, and then to try to generate viral instant social marketing exposure through many diverse distribution and communication mechanisms on a global and/or targeted local basis. Accordingly, there is a need for a platform to enable mobile device users to easily create, deliver, and share digital media content.

### SUMMARY OF THE INVENTION

This mobile device software application and interrelated mobile device-optimized website social user gallery introduce 1) a new visual layout for images, text, and banners organized by topic, and optionally by date and relative order, 2) new mobile software user interfaces for viewing, creating, emailing, publicly displaying in a mobile website user gallery, partner linking, notifying via alarms, topic updating, and structurally organizing via text definition files and a local, on-device client database, these new visual layouts to empower users to create new content, or repurpose existing content from different topics, 3) new mobile software application client-side software framework marketing mechanisms, configurations, and specifications, 4) interrelated new mobile-optimized website social user gallery to display the publicly shared content sent by registered users from the mobile device software application.

### BRIEF DESCRIPTIONS OF THE DRAWINGS

FIG. 1 shows the mobile application “image unit” layout from the “View” on a mobile device, in accordance with one embodiment of the present invention.

FIG. 2 shows the mobile application “image unit” layout after new banner rotation from the “View” screen on a mobile device, in accordance with one embodiment of the present invention.

FIG. 3 shows the mobile application “image unit” layout after topic selection changes to user's “My iCandi” on a mobile device, in accordance with one embodiment of the present invention.

FIG. 4 shows the mobile application “image unit” layout after topic selection changes to other topics on a mobile device, in accordance with one embodiment of the present invention.

FIG. 5 shows the flip/hover HTML webpage layout of “content unit” description that appears when a user presses the 3-line stylized caption area on the “image unit” on a mobile device, in accordance with one embodiment of the present invention.

FIG. 6 shows the mobile application “Create” screen on a mobile device, in accordance with one embodiment of the present invention.

FIG. 7 shows the mobile application “Create-Preview” screen on a mobile device, in accordance with one embodiment of the present invention.

FIG. 8 shows the mobile application “Create-New Picture” screen on a mobile device, in accordance with one embodiment of the present invention.

FIG. 9 shows the mobile application “Create-Edit Captions” screen on a mobile device, in accordance with one embodiment of the present invention.

FIG. 10 shows the mobile application “Create-Edit Font” screen on a mobile device, in accordance with one embodiment of the present invention.

FIG. 11 shows the mobile application “Create-Edit Text Color” screen on a mobile device, in accordance with one embodiment of the present invention.

FIG. 12 shows the mobile application “Create-Edit Background Color” screen on a mobile device, in accordance with one embodiment of the present invention.

FIG. 13 shows the mobile application “Create-Edit URL/Audio” screen on a mobile device, in accordance with one embodiment of the present invention.

FIG. 14 shows the mobile application “Create-Edit Description” screen on a mobile device, in accordance with one embodiment of the present invention.

FIG. 15 shows the mobile application “Create-Select Banner” screen on a mobile device, in accordance with one embodiment of the present invention.

FIG. 16 shows the mobile application “Create-Customize Banner” screen on a mobile device, in accordance with one embodiment of the present invention.

FIG. 17 shows the mobile application “Create-Design Banner” screen on a mobile device, in accordance with one embodiment of the present invention.

FIG. 18 shows the mobile application “Create-Design Banner-Select Image” screen on a mobile device, in accordance with one embodiment of the present invention.

FIG. 19 shows the mobile application “Create-Design Banner-Edit Text Lines” screen on a mobile device, in accordance with one embodiment of the present invention.

FIG. 20 shows c e application “Create-Design Banner-Edit Background” screen on a mobile device, in accordance with one embodiment of the present invention.

FIG. 21 shows the mobile application “Create-Design Banner-URL/Sound Bite” screen on a mobile device, in accordance with one embodiment of the present invention.

FIG. 22 shows the mobile application “Create-Design Banner-Banner Info” screen on a mobile device, in accordance with one embodiment of the present invention.

FIG. 23 shows the mobile application “Share-Email Design” screen on a mobile device, in accordance with one embodiment of the present invention.

FIG. 24 shows the top portion of mobile application “Share-Email Preview” screen on a mobile device, in accordance with one embodiment of the present invention.

FIG. 25 shows the bottom portion of mobile application “Share-Email Preview” screen on a mobile device, in accordance with one embodiment of the present invention.

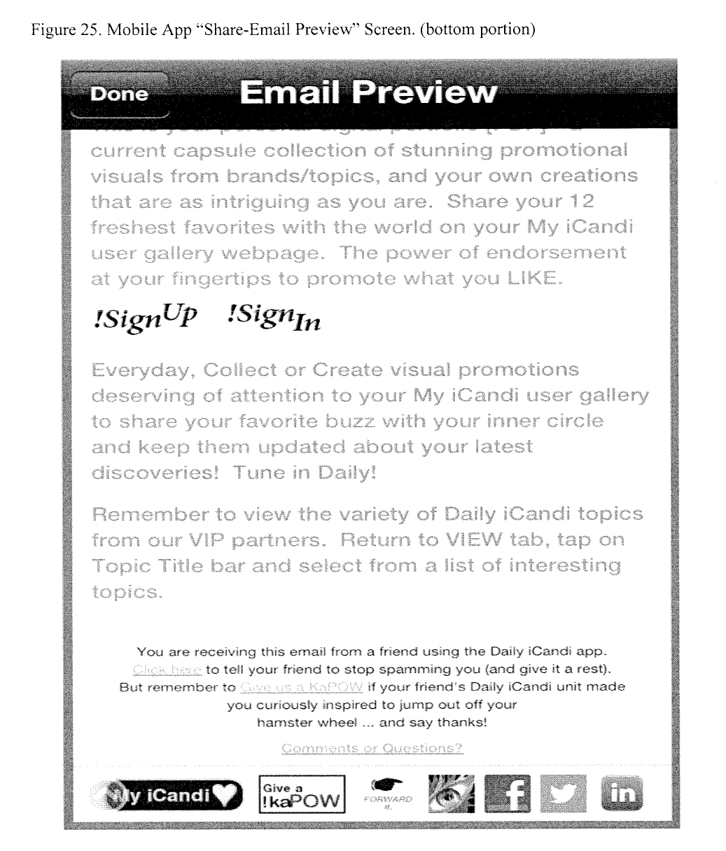

FIG. 26 shows the mobile application “Share-Send to Registered User Mobile Website Gallery” screen on a mobile device, in accordance with one embodiment of the present invention.

FIG. 27 shows the mobile application “Partner Links” screen on a mobile device, in accordance with one embodiment of the present invention.

FIG. 28 shows the mobile application “Partner Links Details” screen on a mobile device, in accordance with one embodiment of the present invention.

FIG. 29 shows the mobile application “Alarms” screen on a mobile device, in accordance with one embodiment of the present invention.

FIG. 30 shows the mobile application “Alarm Setting” screen on a mobile device, in accordance with one embodiment of the present invention.

FIG. 31 shows the mobile application “Topic Updates” screen on a mobile device, in accordance with one embodiment of the present invention.

FIG. 32 shows the mobile application “Topic Catalog” screen on a mobile device, in accordance with one embodiment of the present invention.

FIG. 33 shows the mobile application “Upload Settings” screen on a mobile device for entering mobile site and VIP username and password, in accordance with one embodiment of the present invention.

FIG. 34 shows the mobile application “Create-Upload Button” screen for a topic owner on a mobile device, in accordance with one embodiment of the present invention.

FIG. 35 shows the mobile application “Topic Warning—Cannot View Future Dates” screen dialog on a mobile device, in accordance with one embodiment of the present invention.

FIG. 36 shows the mobile web “iCandi Showcase Image Unit Auto-slideshow Gallery” screen, in accordance with one embodiment of the present invention.

FIG. 37 shows the mobile web “iCandi Showcase Flip/Hover HTML Webpage rendering “content unit” description text definition” screen, in accordance with one embodiment of the present invention.

FIG. 38 shows the mobile web “New User Registration Initial Information” screen, in accordance with one embodiment of the present invention.

FIG. 39 shows the top portion of the mobile web “User Profile” screen, in accordance with one embodiment of the present invention.

FIG. 40 shows the bottom portion of the mobile web “User Profile” screen, in accordance with one embodiment of the present invention.

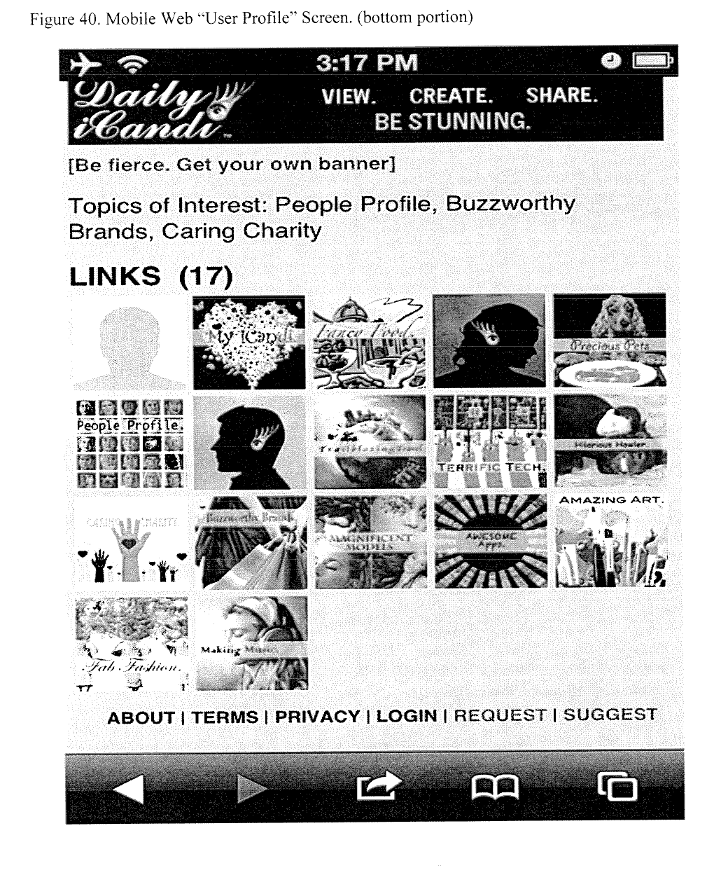

FIG. 41 shows the mobile web “Search Results” screen, in accordance with one embodiment of the present invention.

FIG. 42 shows the mobile web “Topic/Brand User Avatar Into Hover Window” screen, in accordance with one embodiment of the present invention.

FIG. 43 shows the mobile web “My iCandi Image Unit Auto-slideshow Gallery” screen, in accordance with one embodiment of the present invention.

FIG. 44 shows the mobile web “My iCandi Flip/Hover HTML Webpage rendering “content unit” description text definition” screen, in accordance with one embodiment of the present invention.

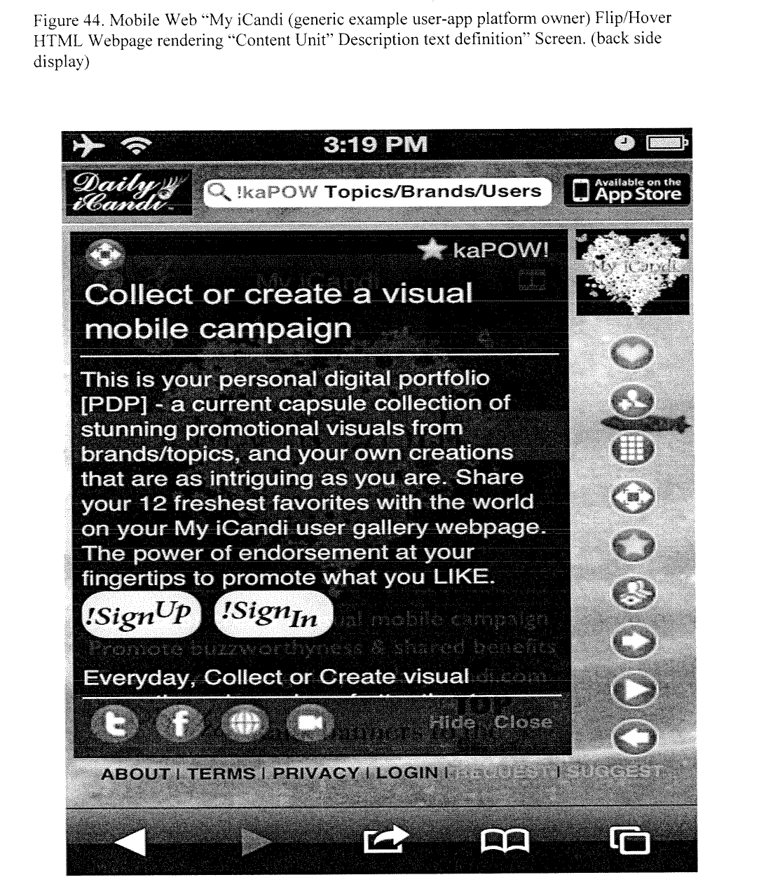

FIG. 45 shows the mobile web “My iCandi” user's grid gallery screen, in accordance with one embodiment of the present invention.

FIG. 46 shows the mobile web “My iCandi” user's grid gallery screen-selected “image unit” in auto-slideshow gallery screen, in accordance with one embodiment of the present invention.

### DETAILED DESCRIPTION

This mobile device software application and interrelated mobile device-optimized website social user gallery introduce 1) a new visual layout for images, text, and banners organized by topic, and optionally by date and relative order, 2) new mobile software user interfaces for viewing, creating, emailing, publicly displaying in a mobile website user gallery, partner linking, notifying via alarms, topic updating, and structurally organizing via text definition files and a local, on-device client database, these new visual layouts to empower users to create new content, or repurpose existing content from different topics, 3) new mobile software application client-side software framework marketing mechanisms, configurations, and specifications, 4) interrelated new mobile-optimized website social user gallery to display the publicly shared content sent by registered users from the mobile device software application.

The scope of this patent application should apply to all digital and physical representations of any likeness of the visual layout content produced by the mobile application software, to any mobile application software which implements like features and key marketing mechanisms, configurations, and specifications present in this mobile application, and to any website which implements like features interrelated with the mobile application software's content, framework, and bidirectional interface connectivity between the mobile application and website involving both topic-defined and user-defined content.

Although the mobile application software only operates on mobile devices running the same mobile operating system, the content created and shared via the software can be broadcast and shared on other computing devices, and internet-connected displays having minimal storage capacity. There is an interface to transmit the stunning visuals created or collected via the mobile app to a special mobile-optimized social user website gallery to publicly display a limited number of recently sent visuals. Any electronic device which can display a modern internet browser can process/render the special webpage URLs for any registered user of our Services, and interactively show this user's favorite visuals sent from the mobile app. Additionally, the registered user's profile will contain preferences, interesting information, trusted mutually-accepted links to other topics/brands/users, and pending link requests to and from other topics/brands/users of the services.

The software may be displayed and created on a mobile (battery-attached/onboard power source) hardware device which can be transported/move along with the movements taken by an individual person. This software will be displayed on the mobile device's visible display, which can also simultaneously project its output via wired/wireless/remote internet connection onto other physical display formats/technologies, with user input via any combination of the device's touch panel screen (usually glass), audio/voice, physical/physiological movement, and any other user generated input which may even occur from remote distances over the internet or other communication medium.

B) Mobile App-Created “Content Unit” User Interface (Smartphones & Tablets), Republishable to Web Server for Viewing in Any Web Browser Running on Mobile Devices (Any Mobile OS), Any Computer, or Internet-Connected Device

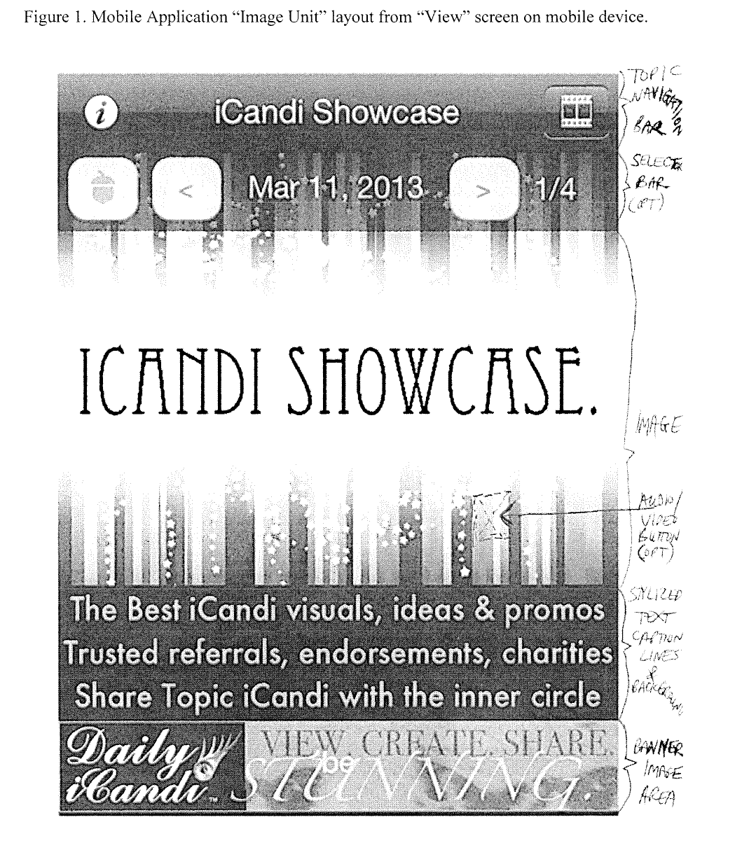

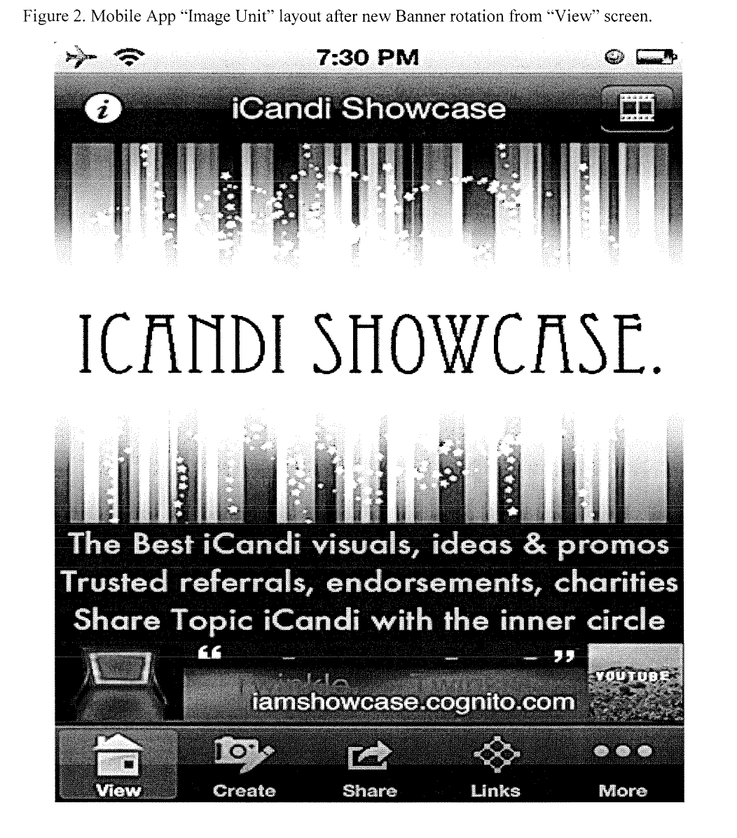

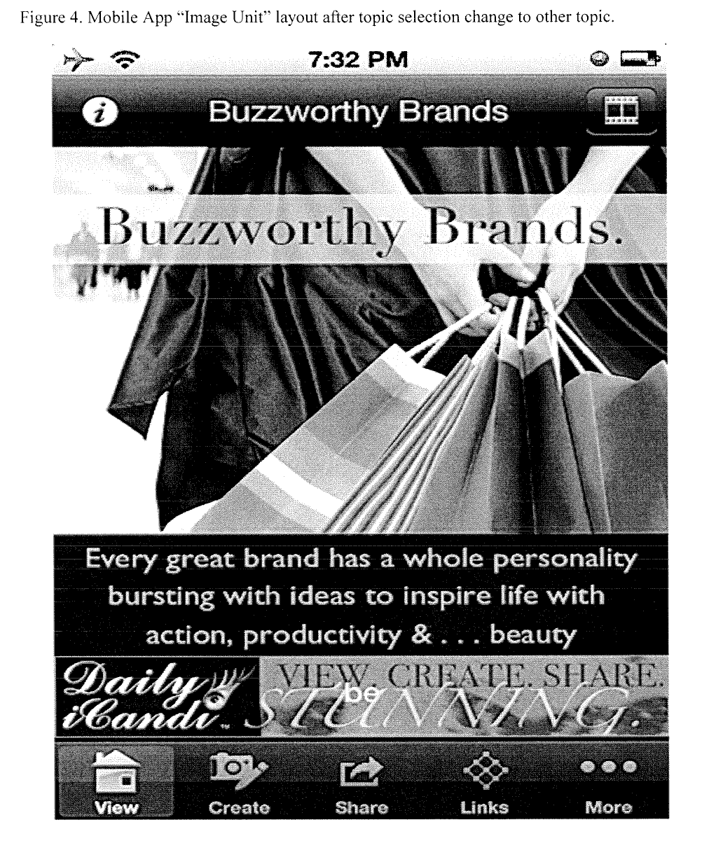

The “Image unit” layout is defined by the following areas on the mobile device display (see FIGS. 1-5). Note that some areas may be optional, or not viewable.

B1. Topic Navigation bar—Displays the current Topic name, Touch the topic name text to bring up user's topic list whose order can be adjusted and stored. Additional topics can be added to the user's topic list via the “Topic Catalog” screen, whose table list of available topics can be updated from a server. When the user selects a topic from their topic list (if an internet connection is active), the app communicates to a topic server to check for new topic updates, and, if available, downloads all necessary text definition files (such as for new “Content Units”) and associated media/image file assets.

B2. Selector bar (Date & Content Order/Capacity)—optional ghosted display bar superimposed over top portion of image, hidden/shown based on single toggle press on image unit area, displays and controls calendar date and content order/capacity via date and content # picker screen (when date text is pressed) or via left and right +/−1 day buttons. There is also a favorite (“Acorn”) button to the far left of the ghosted date bar which allows this content unit to be stored as a favorite reference within this topic, or copied to the user's special “My iCandi” topic (usually 2^{nd} topic in topic list) for storage and potential repurposing by the user.

B3. Image (Photo or Digital Art, original or modified)—this image area will take up the majority of the overall IMAGE unit area (which may consist of the Topic Navigation bar, ghosted/superimposed date bar, stylized text caption area, banner graphic area, and optional superimposed Audio/Video/Volume button. The image unit will be horizontally aligned (x-axis) with the other IMAGE unit objects (standard & optional) In other words, no individual component of the image unit will be independently laid out on the x-axis, such that there are no other components with partial presence within the x-axis values of the image area. There may be other IMAGE unit objects superimposed over some portion of the image area, but there will always be a majority of the rectangular image area visible. The rectangular area is currently shaped in a 4:3 (4 units horizontal to 3 units vertical) orientation ratio, such as 640×480 pixels or 320×240 pixels on the mobile device, but this size and ratio may change in the future). This image can be selected from the mobile device's photo library or taken directly from the device's camera, then it can optionally be stylized using the photo editing and customizing tools within a photo library included with the mobile software.

B4. Stylized Text Caption Lines and Background area—this text caption area will occupy a vertically shorter area than the image area, and be generally located vertically below the image area. It should be horizontally aligned (x-axis) with the other IMAGE unit objects (standard & optional) In other words, no individual component of the stylized text caption line area will be independently laid out on the x-axis, such that there are no other components with partial presence within the x-axis values of the stylized text caption line area. This area possess multiple text lines of information, where each line can hold a maximum number of characters that is greater than 40. Currently, there are multiple text lines, usually 3, but any of those lines could be empty or contain only space characters to appear that there is no line present. Also, the absolute or relative size of this stylized text caption line area should not be fixed or constrained. The text characters can be wholly, or even in the future, be stylized on a per line or per character or group of characters-basis, with respect to font style, font text color, and potentially font size. The background color behind/around the text character pixels can be selected as well to create a solid color block region around the image area. This stylized background color block may wrap vertically to the left and right of the image area as well, and should be contiguous and adjacent to the image area.

B5. Banner image area (consisting of background horizontal image, optional superimposed left rectangular or square image, optional superimposed right rectangular or square image, and optional superimposed multiple stylized text headlines)—this banner image area will occupy a vertically shorter area than the stylized text caption line area, and be generally located vertically below the stylized text caption line area, but may also be superimposed over the image area. These banners can originate from the app platform operator, its approved partners and topics (either using the default banner associated with the “content”/“image” unit, or selecting another banner specific for this topic from a selector, or be generated by users copying a banner image designed outside of the mobile app, copied to their photo library, and imported, or using the custom banner design tools in the mobile app (which allow creation of a background horizontal image, optional superimposed left rectangular or square image, optional superimposed right rectangular or square image, and optional superimposed multiple stylized text headlines)). These custom banners may require in-app purchase to be moved into the banner selector for use in the user's “My iCandi” topic and content creations. Users may submit their banners to app platform operator for consideration to be distributed as a public banner in one of its topics or one of its VIP topic partners' topics. It should be horizontally aligned (x-axis) with the other IMAGE unit objects (standard & optional) In other words, no individual component of the banner area will be independently laid out on the x-axis, such that there are no other components with partial presence within the x-axis values of the banner area. The banner area also includes a marquee vertical scrolling of HTML-formatted text to inform topic/user/personalized information, and a horizontally scrolling display of multiple avatar images in rotating grouped sets. The avatar images can optionally be single-clicked to launch an associated webpage, or can optionally be double-clicked to refresh the entire marquee ticker text and avatar image sets, in round-robin fashion, for the specific My iCandi username defined for that avatar, by accessing the ticker file located on the app platform's web server.

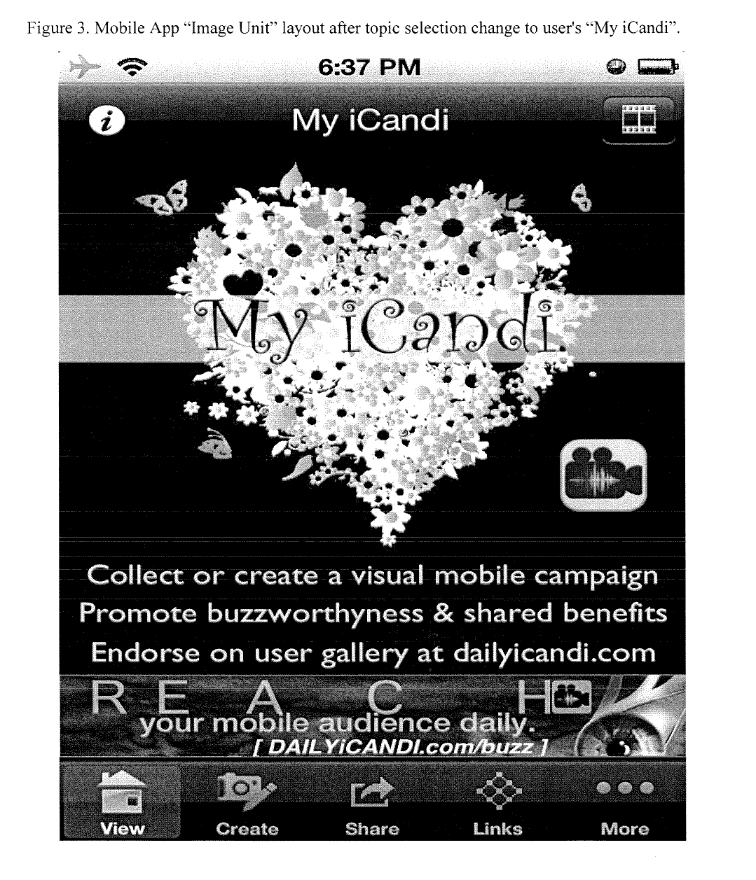

B6. Audio/Video/Volume (AV) button—this optional superimposed button may appear over a portion of the image area (see FIG. 3) when the associated parameter (webpage URL/audio) references either a local file or internet URL that references audio or video content, which will play when the user presses this button from the mobile app software. Currently, this button appears in the lower right portion of the image unit. It will disappear for other units whose webpage URL/audio parameter does not reference an audio/video content source location. This button will toggle operation between playing and stopping the audio or video source, and may also change its button image to reflect a silence/volume off functionality if audio associated to another user interface source, such as a banner, is currently playing. Outside of the app, this AV button may have functionality on our mobile-optimized website gallery userpages, but will not have functionality on other social media services or via email “image” unit attachment.

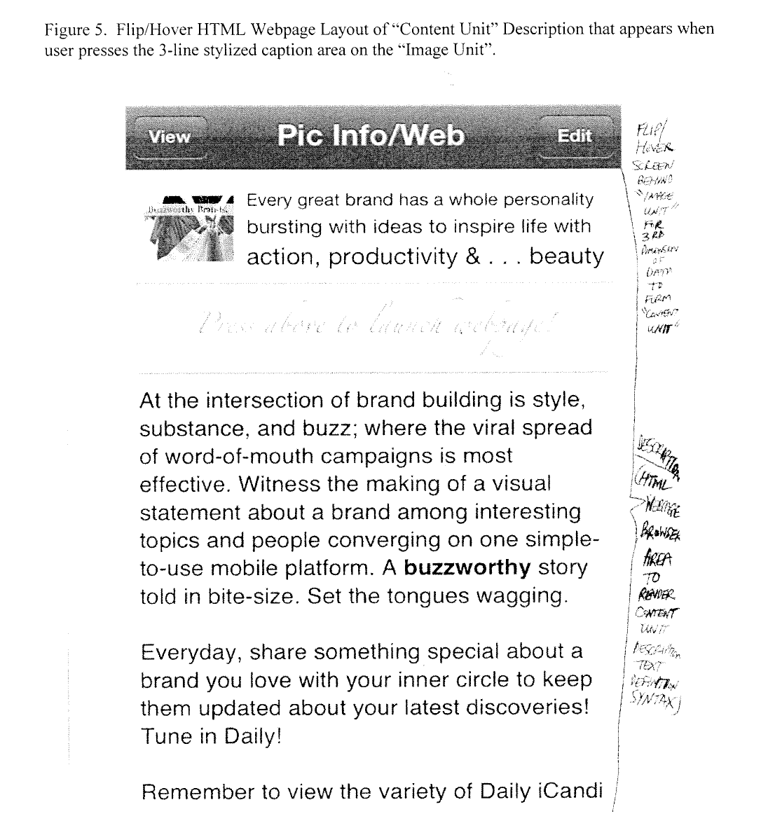

B7. HTML webpage browser area to render content description text definition syntax—this optional hidden browser window (see FIG. 5) may only be available for display in the mobile app (when you press the text caption line area) or in the mobile-optimized website user gallery (when pressing on the visible area of “image” unit, which was sent from the mobile app by the registered user). The visible image and stylized text caption line and banner areas will flip to become invisible, while the HTML webpage browser area appears visible by sliding/appearing over these areas. A return button or user interface action will reverse this operation to show the image/stylized text caption lines/banner area again, while hiding the HTML webpage browser. This area may be optionally visible on physical reproductions of the IMAGE unit. The core IMAGE unit can be “burned” or area-captured digitally for sharing locally, privately, or publicly, for potential eventual reproduction and duplication onto physical representations.

C) Mobile App Software Operation and Text File/Database Structure

C0.1 Hardware presence—These app definitions apply to any software displayed and created on a mobile (battery-attached/onboard power source) hardware device which can be transported/move along with the movements taken by an individual person. This software will be displayed on the mobile device's visible display, which can also simultaneously project its output via wired/wireless/remote internet connection onto other physical display formats/technologies, with user input via any combination of the device's touchpanel screen (usually glass), audio/voice, physical/physiological movement, and any other user generated input which may even occur from remote distances over the internet or other communication medium.

C0.2 Online Communication/Internet connection—This software does not require an online communications/Internet connection to operate. All content can be created independently on the device either originally (by taking photos or using personal images in the device's library, generating story text/HTML web pages directly, or selecting music on the device (currently Apple iPod/iTunes library)), or by repurposing/modifying aspects of collected “content units” from other topics present in the app software. The core content for other topics in the app resides in the local storage on the mobile device. An online Internet connection is only needed to download any content specified via internet weblinks, to download any new content for a specific topic into the device, to download any newly selected topics' initial configuration and content information, or to share “content units” to others via email, other social media networks, or to the mobile-optimized website server owned by the app platform operator, and/or its selected partners. Therefore, users of the mobile app do not need to login via username and password entry to use most features of the software. This is primarily needed when accessing content from a registered user's webpage gallery contents in the app, or when sending and sharing new “content units” to the user's mobile website gallery.

The key functional software features are detailed below:

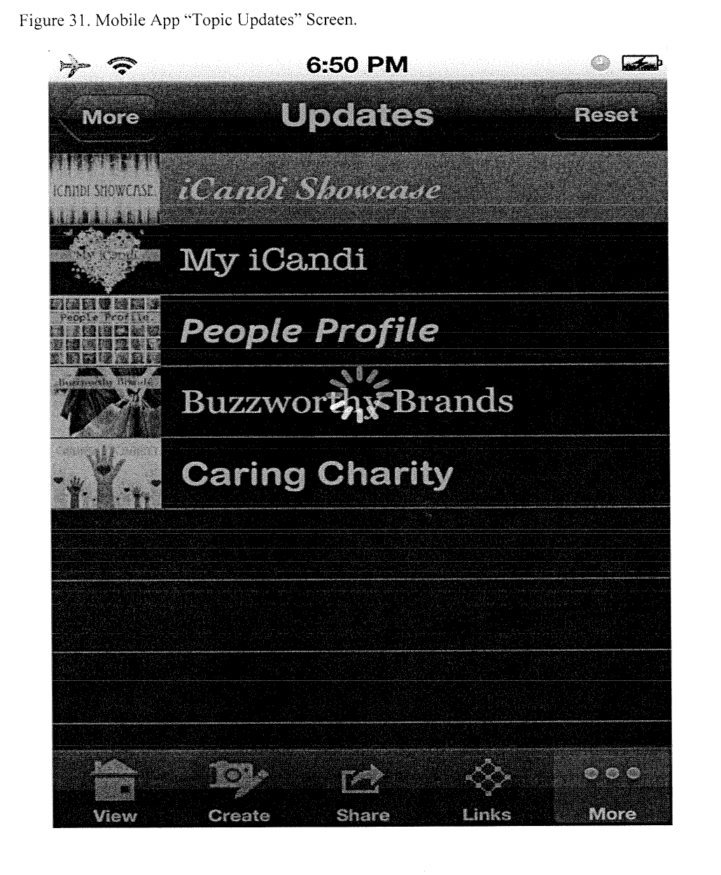

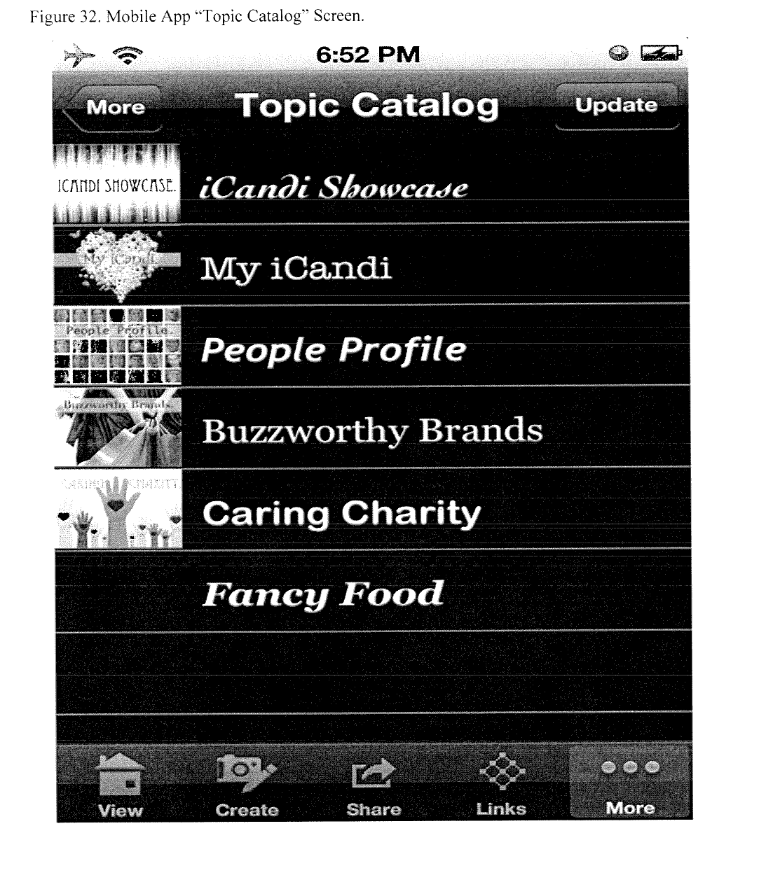

C1. Topics from multiple users/brands/businesses/organizations which individually contain Content (text/style definitions/images/audio/video/weblinks/webpages) organized by specific date (yearly calendar) into multiple “content unit” sets/campaigns per day—Displays the current Topic name, Touch the topic name text to bring up operator's topic list whose order can be adjusted and stored. Additional topics can be added to the user's topic list via the “Topic Catalog” screen (see FIG. 32), whose table list of available topics can be updated from a server. When the user selects a topic from their topic list (if an internet connection is active), the app communicates to a topic server to check for new topic updates, and, if available, downloads all necessary text definition files (such as for new “Content Units”) and associated media/image file assets (see FIG. 31).

C2. Private, special Content Collection & Creation topic (“My iCandi”)—(sec FIG. 3) contains all “content units” that a user has both created independently on the device either originally (by taking photos or using personal images in the device's library, generating story text/HTML web pages directly, or selecting music on the device (currently Apple iPod/iTunes library)), or collected and, optionally repurposed/modified aspects of collected “content units” from other topics present in the app software. This “My iCandi” topic can receive and store copies of “content units” from other topics. When viewing another topic's visuals, press the image to ensure the “ghosted date/favorite button bar” is visible, press the “Acorn” favorite button, and save to “My iCandi” topic.

C3. Extra (3^{rd}) Dimension user interface hover/flip HTML webpage browser screen—(see FIG. 5) renders content description, and HTML text editor for interactive modification. When viewing any “content unit”, press the 3-line caption area to bring up the “Pic Info/Web” screen to view its webpage description. You can press the “Edit” button to display the HTML text definition syntax, make any modifications, then press the “Save” button to view the new description webpage to save the changes for this “content unit” to the client database and to view the new description webpage. You can include interactive HTML web elements and features, such as <iframe> embedded audio & video players, and other widgets.

At the top of the “Pic Info/Web” description screen, there is a thumbnail image and 3-line caption area that, when pressed, will launch the main webpage URL link stored for this “content unit”.

C4. User Interface & Functional Tools to Create Brand New “Content Units” or to Modify/Repurpose favorited “content units” from other app topics into newly customized blended “units”. Any user has the ability to create and modify collected “content units” in their personal “My iCandi” topic (usually the 2^{nd} topic in the topic list) on their mobile device. From the app's Create tab, the changeable aspects of any “content unit” are picture (image/photo, enhanced with available editing/cropping tools), 3-line captions, initial banner display, text font & color, background color, main webpage URL or local/internet-hosted audio, and HTML web-layout description (to render via flip/hover display to create a “3^{rd} dimension” of data).

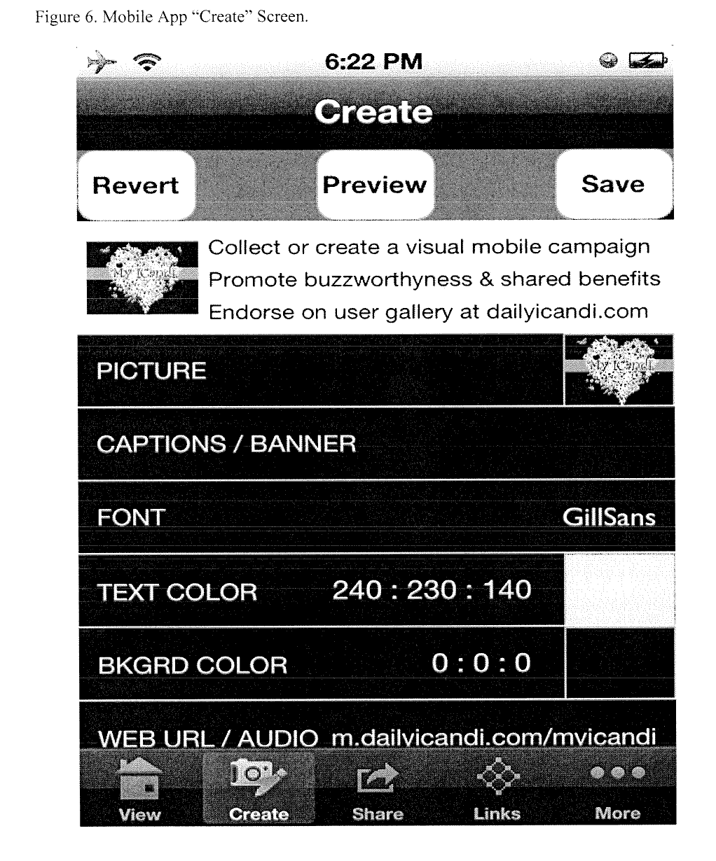

C4.1. The “Create” main screen (see FIG. 6) displays a thumbnail image and 3-line caption of the currently saved “content unit”. There is a table with individual selections to change aspects of the “content unit”. This table interactively shows the currently selected PICTURE thumbnail image, font type, text color (Red/Green/Blue), background color (Red/Green/Blue), and web URL/audio link, and marquee ticker's My iCandi username (or (!)promoted username) that is a shortcut to a file on the app platform server with a special custom-defined file format, defining the following:

* First, the vertical scrolling HTML-acceptable text;

* A blank line (2 line feeds) to end the marquee text section;

* Then, multiple lines of comma-separated avatar image/web page (single-click)/round robin ticker username (double-click) definitions.

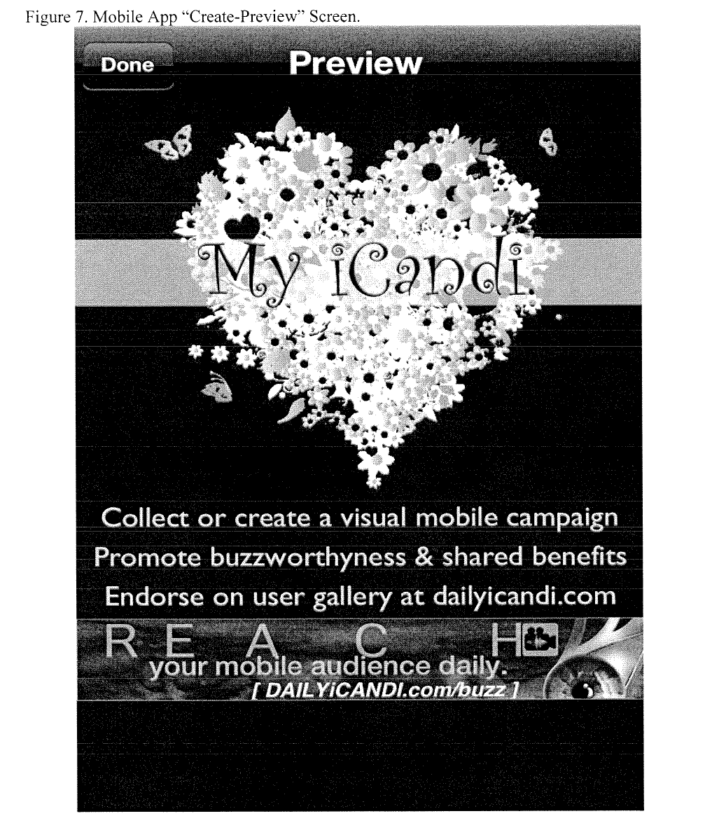

The “Preview” button shows a new screen (see FIG. 7) that displays the appearance of the “image unit” portion of the “content unit”. You can either discard your modifications back to the saved state by pressing the “Revert” or save the current settings to the “content unit” client database by pressing the “Save” button. This screen functionally works properly in both landscape & portrait orientations.

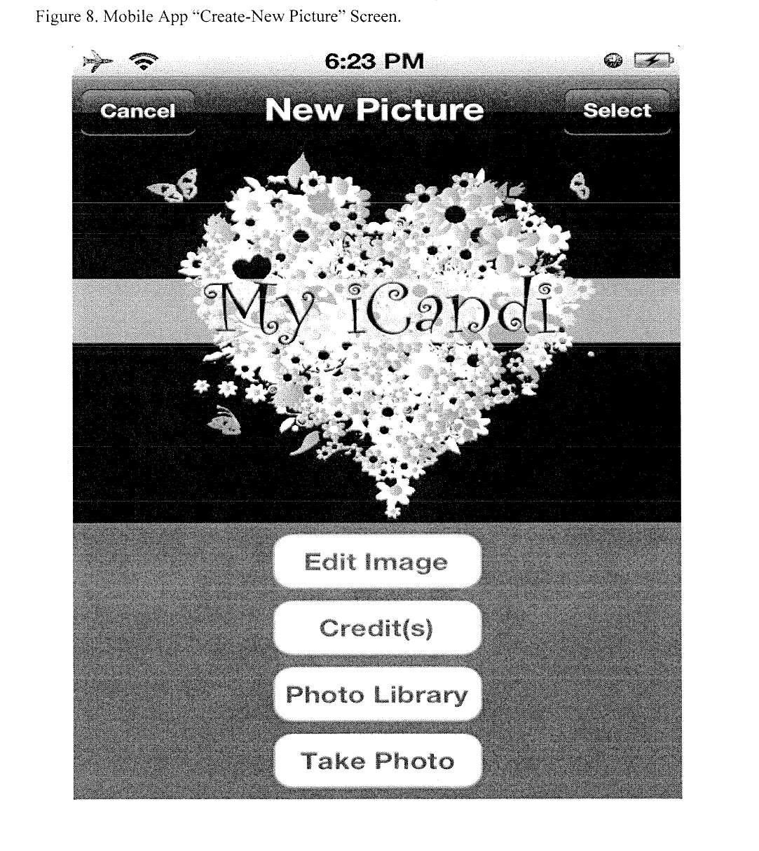

C4.2. The “Create-New Picture” screen (see FIG. 8) allows you to take a photo from the onboard device camera or from the photo library in the device, stylize/crop the image using editing software tools, and enter image/talent credit information to be shown in the “content unit” description. This screen functionality works properly in both landscape & portrait orientations.

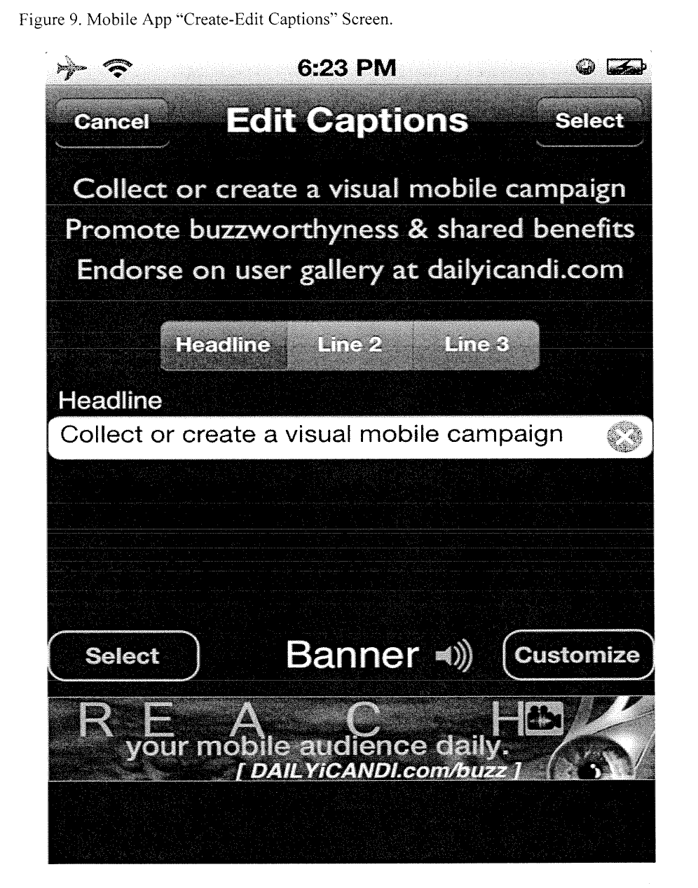

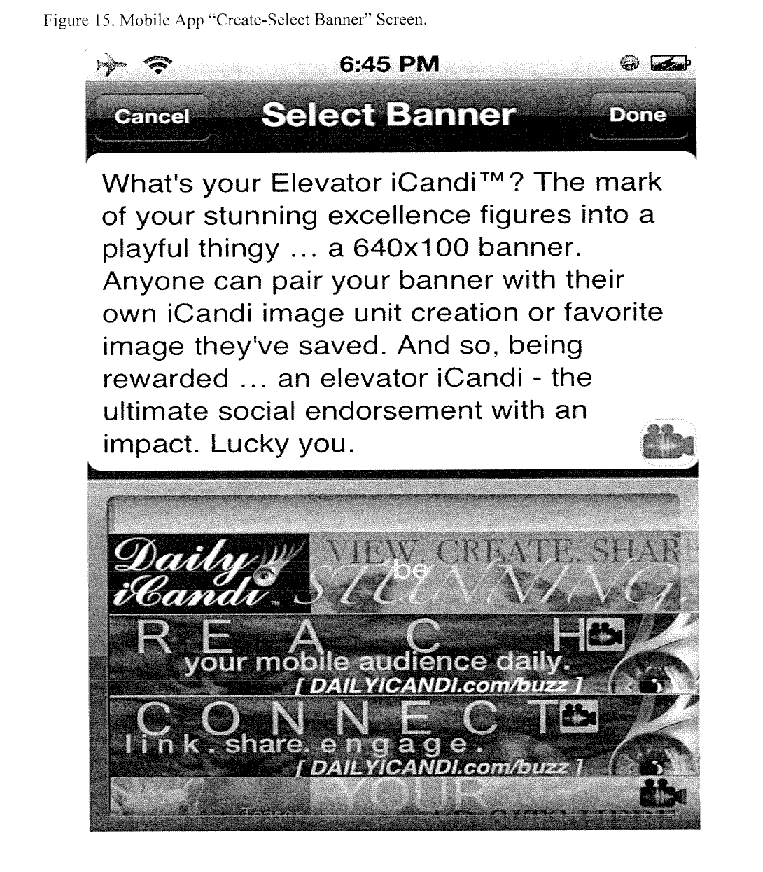

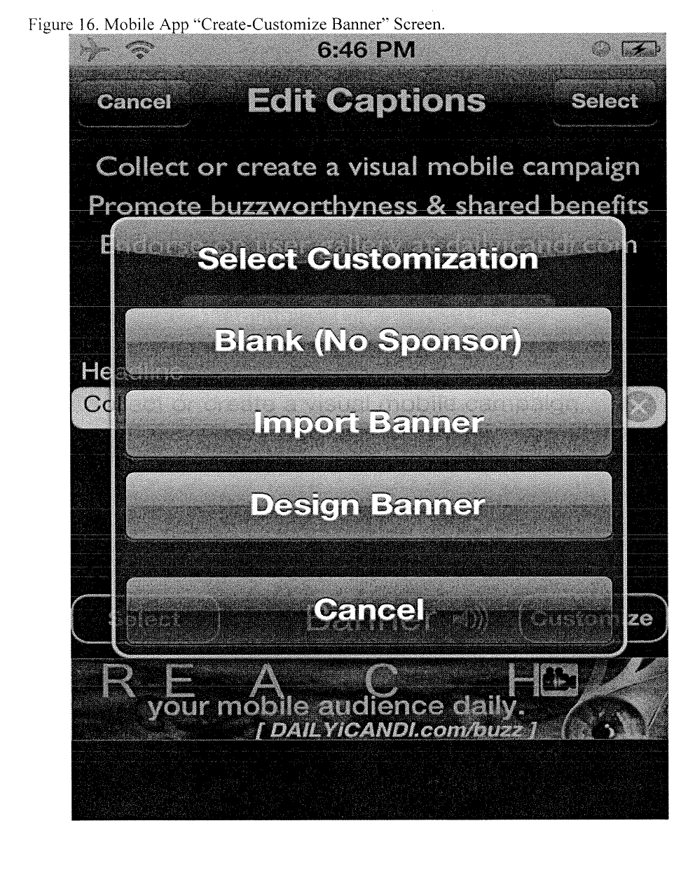

C4.3. The “Create-Edit Captions/Banner” screen (see FIG. 9) allows you to enter any of three caption lines (less than 41 characters per line) and select a custom banner (see FIG. 15) that has either been supplied by the app platform operator and/or its VIP partners, or created by the user after authorization by the app platform operator. There is a “Customize” banner button (see FIG. 16) which provides screens and advanced tools to create special banners, URL weblinks, and banner descriptions, which are defined in section C5 of this document. This screen functionality works properly in both landscape & portrait orientations.

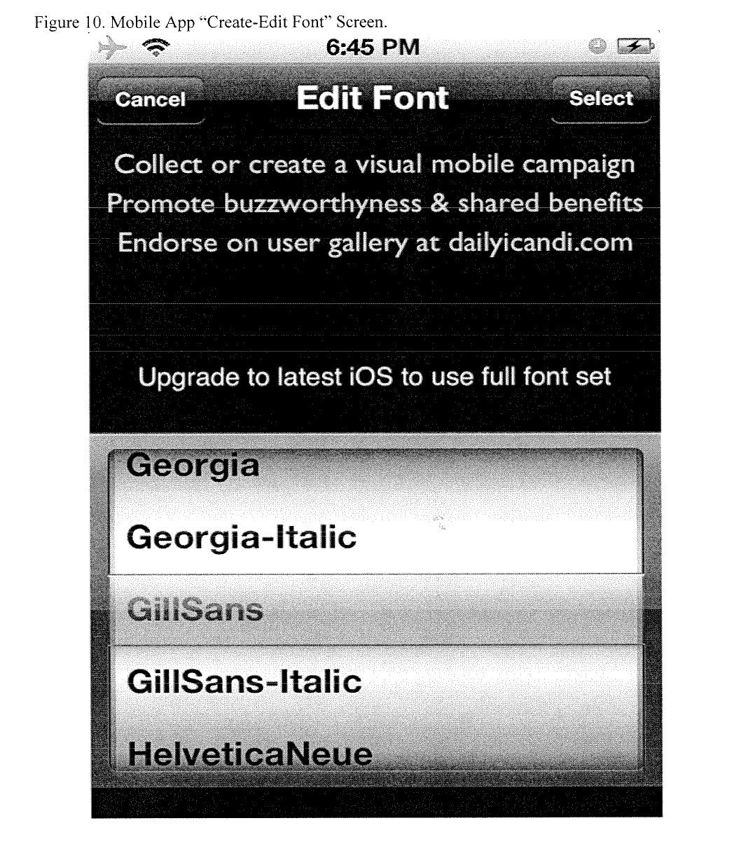

C4.4. The “Create-Edit Font” screen (see FIG. 10) allows the selection and interactive display of a font for the text characters in the 3-line caption style. Press “Select” button to store font selection. Some fonts may only be available in newer versions of the mobile operating system. This screen functionality works properly in both landscape & portrait orientations.

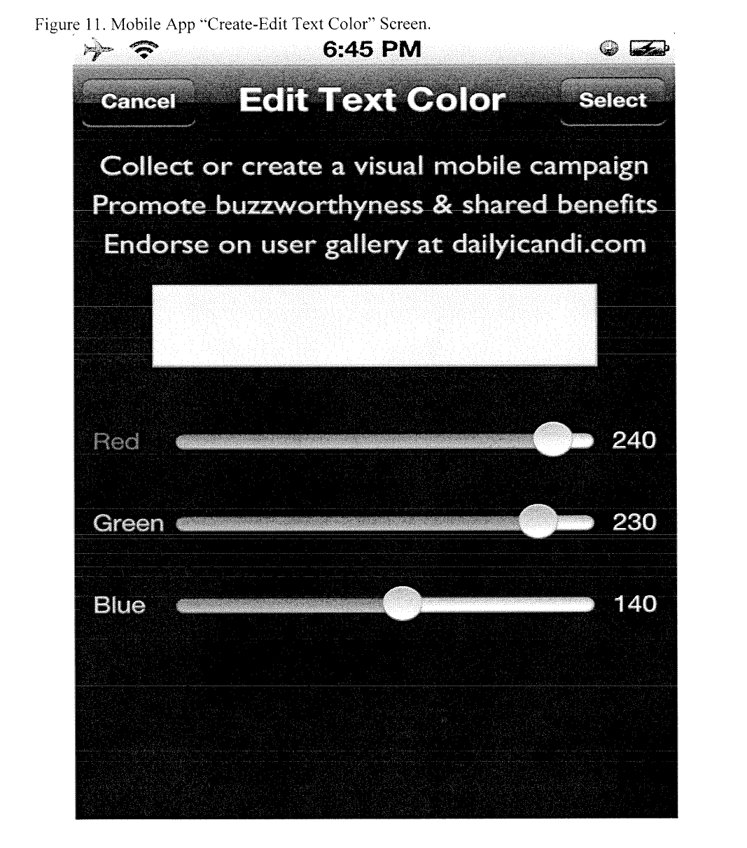

C4.5. The “Create-Edit Text Color” screen (see FIG. 11) allows the selection and interactive display of a color for the text characters in the 3-line caption by moving 3 sliders for the Red/Green/Blue components of the color. This screen functionality works properly in both landscape & portrait orientations.

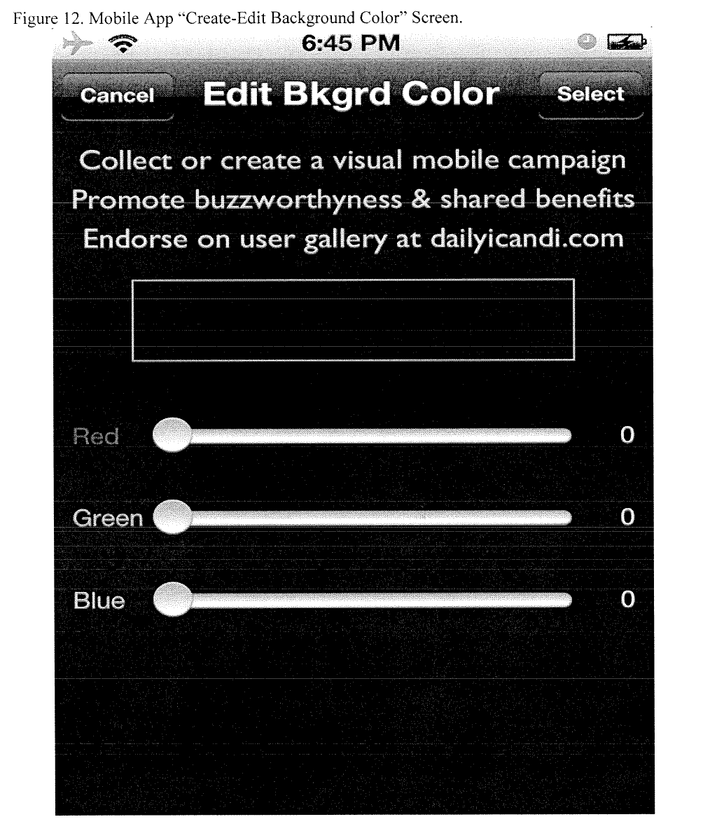

C4.6. The “Create-Edit Background Color” screen (see FIG. 12) allows the selection and interactive display of a color for the background area surrounding the text characters in the 3-line caption by moving 3 sliders for the Red/Green/Blue components of the color. This screen functionality works properly in both landscape & portrait orientations.

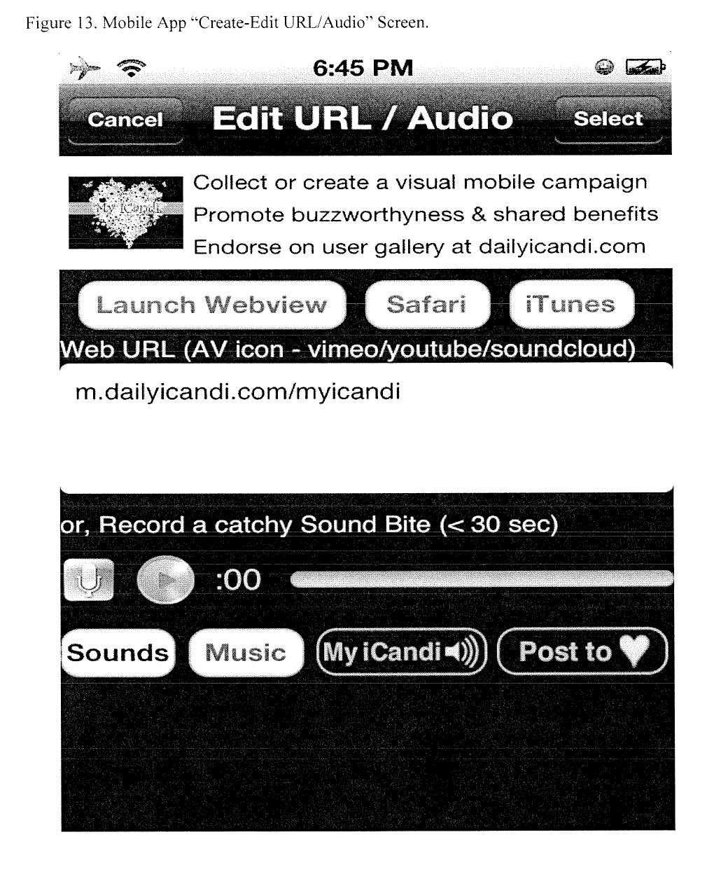

C4.7. The “Create-Edit URL/Audio” screen (see FIG. 13) allows the selection and interactive playback of either a webpage URL link or an audio file (voice recording/sound bite/music on device/weblink to audio file). This screen functionality works properly in both landscape & portrait orientations.

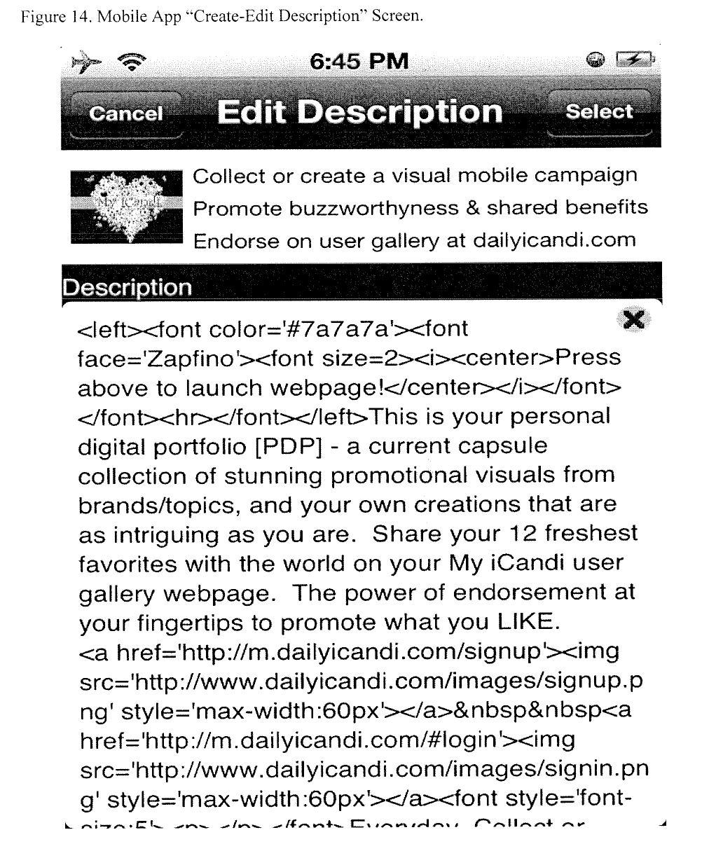

C4.8. The “Create-Edit Description” screen (see FIG. 14) allows the viewing and editing of the “content unit”'s description webpage HTML text definition syntax. It can include interactive HTML web elements and features, such as <iframe> embedded audio & video players, and other widgets. This screen functionality works properly in both landscape & portrait orientations.

C4.9 Create Save button Processing and Output functionality—When the user hits the “Save” button all of these “Create” parameters that were set by the user are saved into their respective client database field entries for that specific topic, date (year, month, day), and slide/unit #. This is similar to the automatic topic updating which is performed (if an internet connection is active) for each topic displayed in the user's topic list, shown on the “View” screen. In this case, the app communicates to a topic server to download and check an UPDATES instruction text definition file for any new update instructions, and, if there are new updates, to download text definition files with 1 or more update modifications or additions to perform for selected client database records for that topic, and to download associated media/image file assets to store in that topic's defined directory for the app on the client mobile device. The changes to the client database appear on the app's “View” screen “Content Units”, which are selected using various topic, date (year, month, day), and slide/unit # combinations, or viewed for a specific day in an optional slideshow display. Additionally, a portion of an individual slide/unit's client database record may optionally be available to be output, such as via email, to the app platform operator, or possibly any other recipient defined by the user.

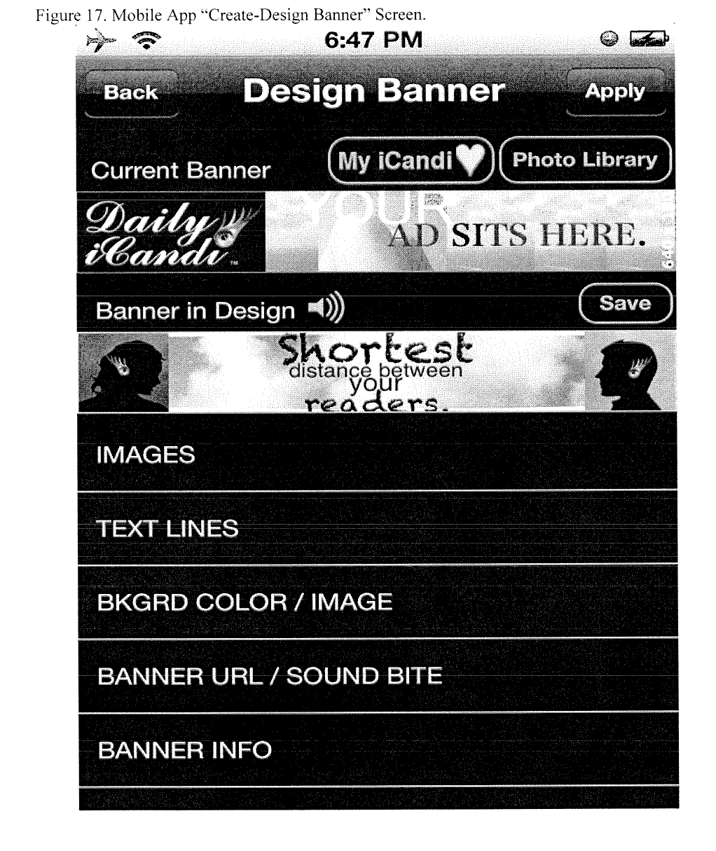

C5. Customize Banner Design user interface and interactive display software—When viewing your “My iCandi” topic, from the “Create-Edit Captions/Banner” screen, you can press the “Customize” button, then the “Design Banner” button (see FIG. 16), to display the user interface elements to interactively create various aspects of your banner, save/authorize the banner, share it to your registered user's mobile-optimized website gallery profile page, save it to your device photo library, and apply it for use with your “content units” which can be shared in many ways (see FIG. 17). There is a table to allow selection of images, text lines, background color & image, webpage URL or audio sound bite, and banner information (industry, keywords, description (viewed when banner is focus-selected in picker roll).

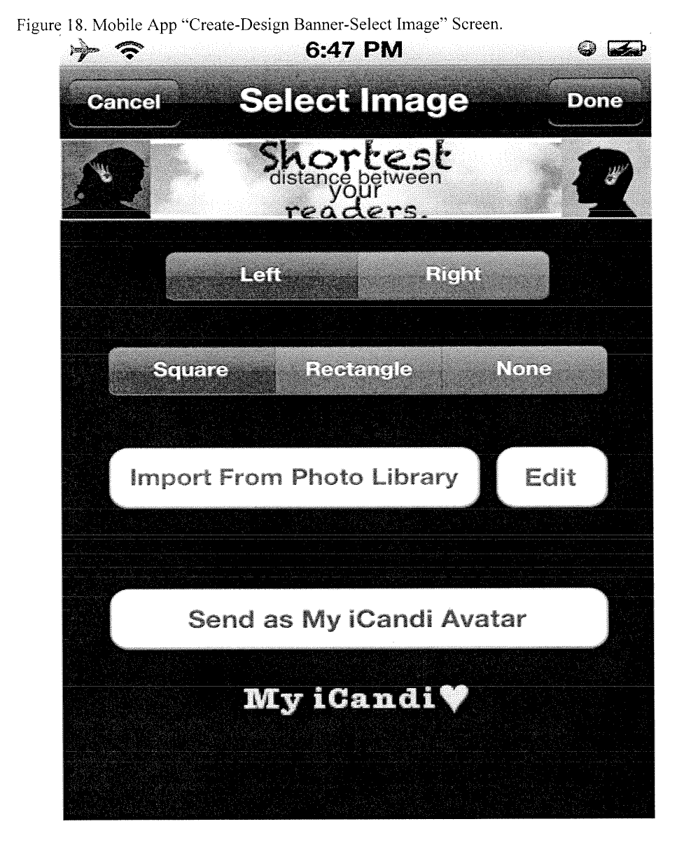

C5.1. The “Create-Design Banner-Select Image” screen (see FIG. 18) allows the selection/positioning/sizing/editing of images from the device's photo library, and the interactive viewing of the current banner in design as changes are made. This screen also allows a specific image to be uploaded as the user's avatar image on their profile page in their mobile-optimized website user gallery.

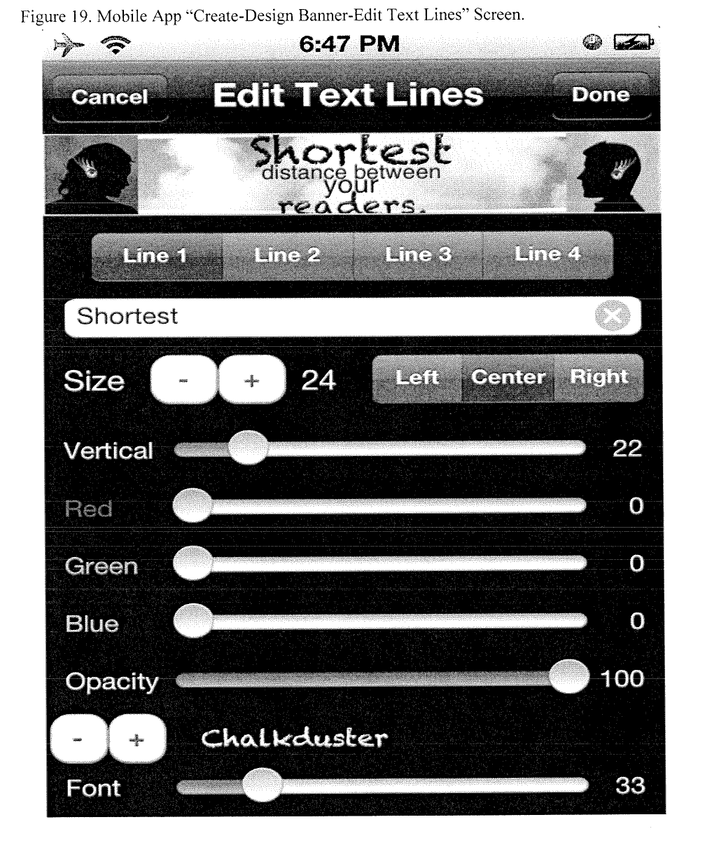

C5.2. The “Create-Design Banner-Edit Text Lines” screen (see FIG. 19) allows the definition/sizing/horizontal & vertical positioning/coloring (Red, Green, Blue) & opacity/font styling of multiple text lines in the banner, and the interactive viewing of the current banner in design as changes are made.

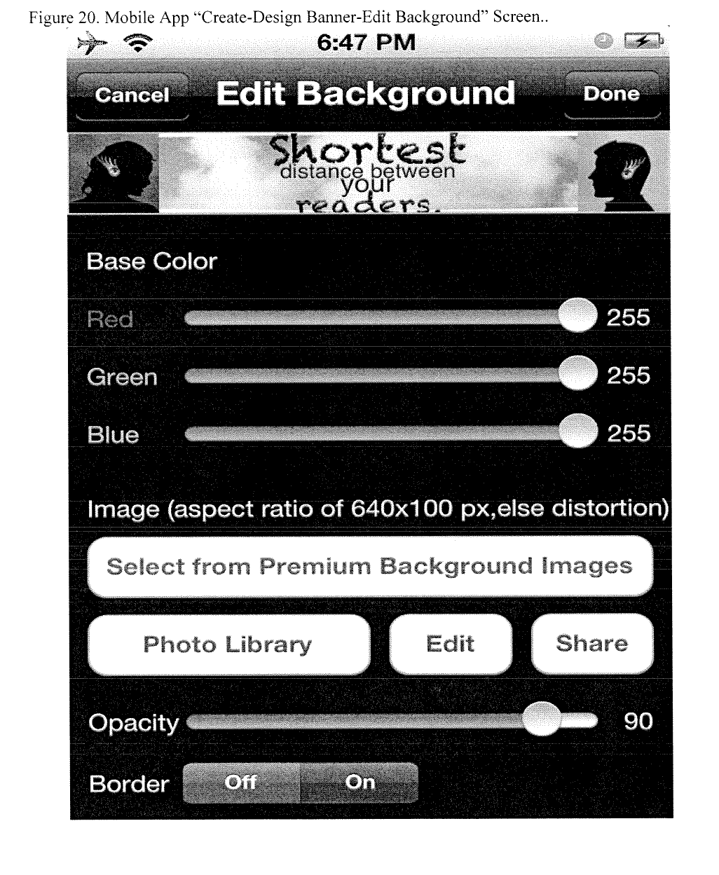

C5.3. The “Create-Design Banner-Edit Background” screen (see FIG. 20) allows the selection of the banner background color (Red, Green, Blue sliders), and the selection/styling/opacity/border frame of a background image from either the device's photo library or a set of premium pre-selected background images, and the interactive viewing of the current banner in design as changes are made.

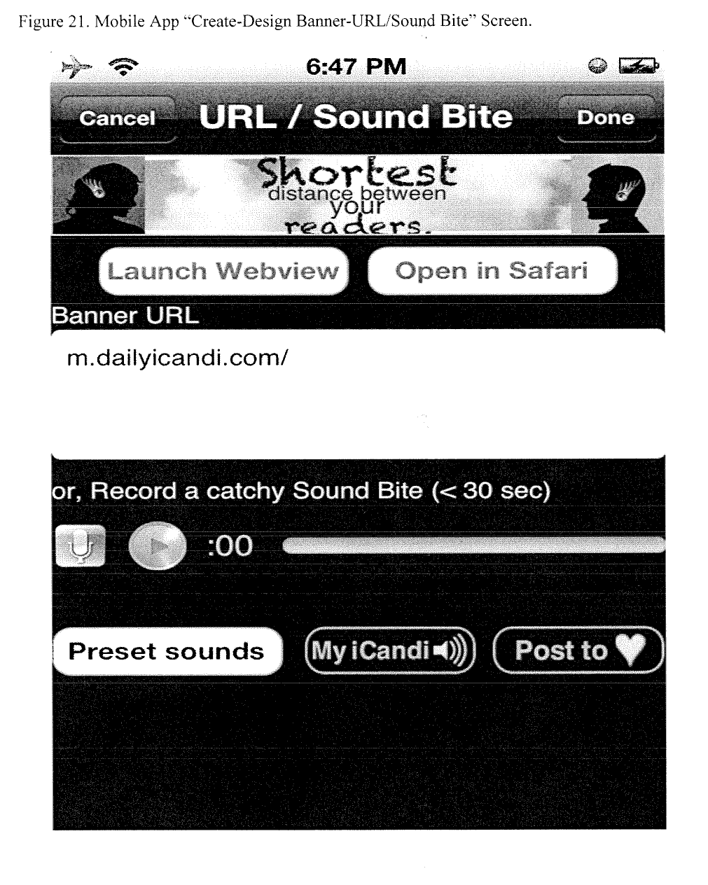

C5.4. The “Create-Design Banner-URL/Sound Bite” screen (see FIG. 21) allows the selection and interactive playback of either a webpage URL link or an audio file (voice recording/sound bite/weblink to audio file).

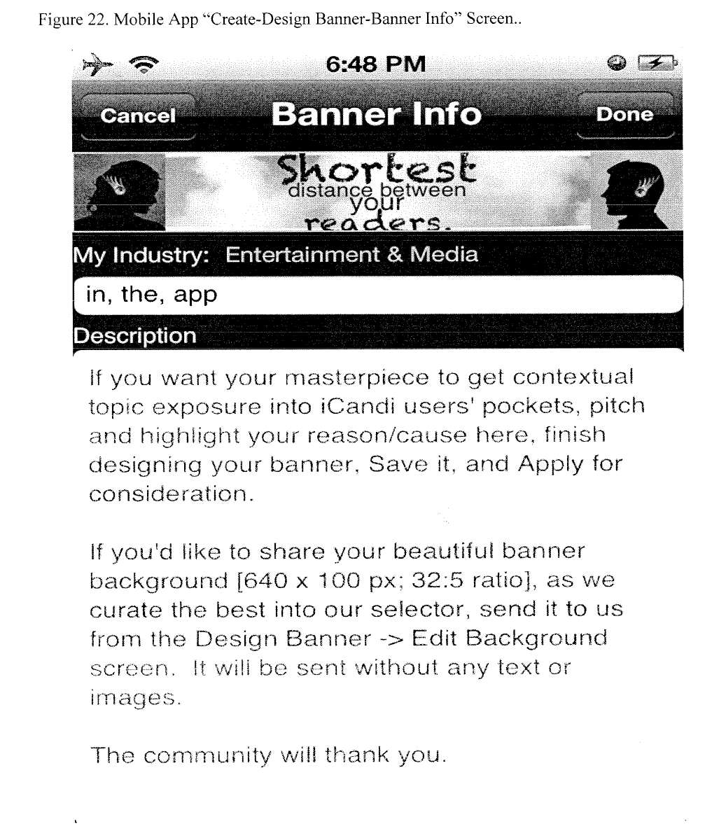

C5.5. The “Create-Design Banner-Banner Info” screen (see FIG. 22) allows the definition of the banner's industry category, keyword tags, and informative description using HTML webpage syntax or plain text (to be displayed when the banner is focus-selected in the picker roll).

C5.6 Create-Design Banner Save button Processing and Output functionality—When the user hits the “Save” button all of these “Create-Design Banner” parameters that were set by the user to generate the interactively displayed visual banner representation under the “Banner in Design” title, the banner image and representative banner information text file are saved to the mobile device, depending upon the authorization provided by the user. Upon redemption of that authorization, the banner image and information text file will be copied and time-stamped on the mobile device, and permitted to be sent to the registered user's mobile website user gallery profile or saved to the general photo library on the mobile device. To use and select the banner for use with other “My iCandi” “image unit” creations, additional approval may be required, and requested from the app platform operators by the user via the “Apply” button.

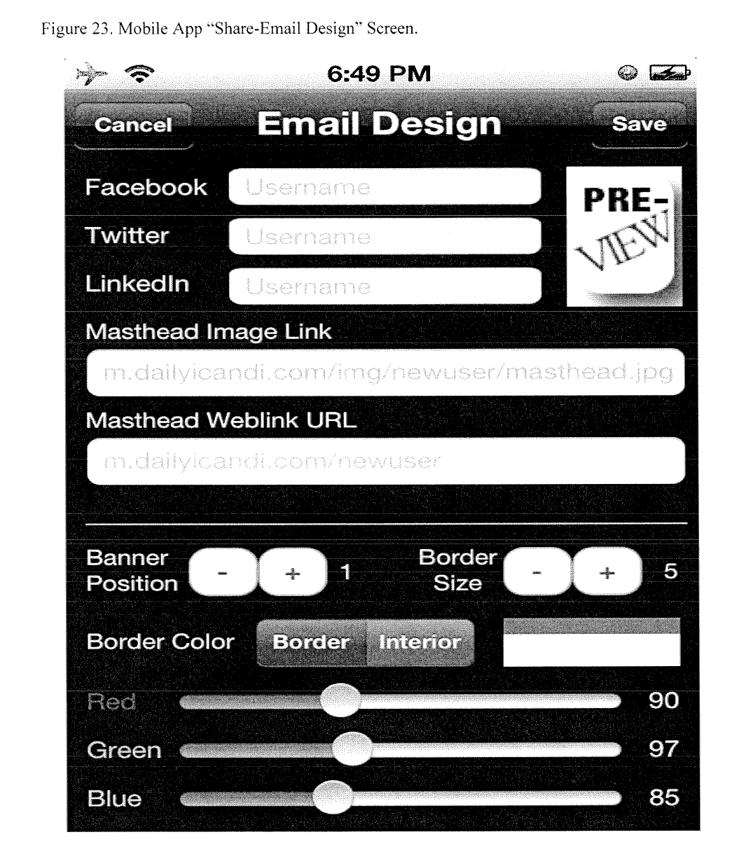

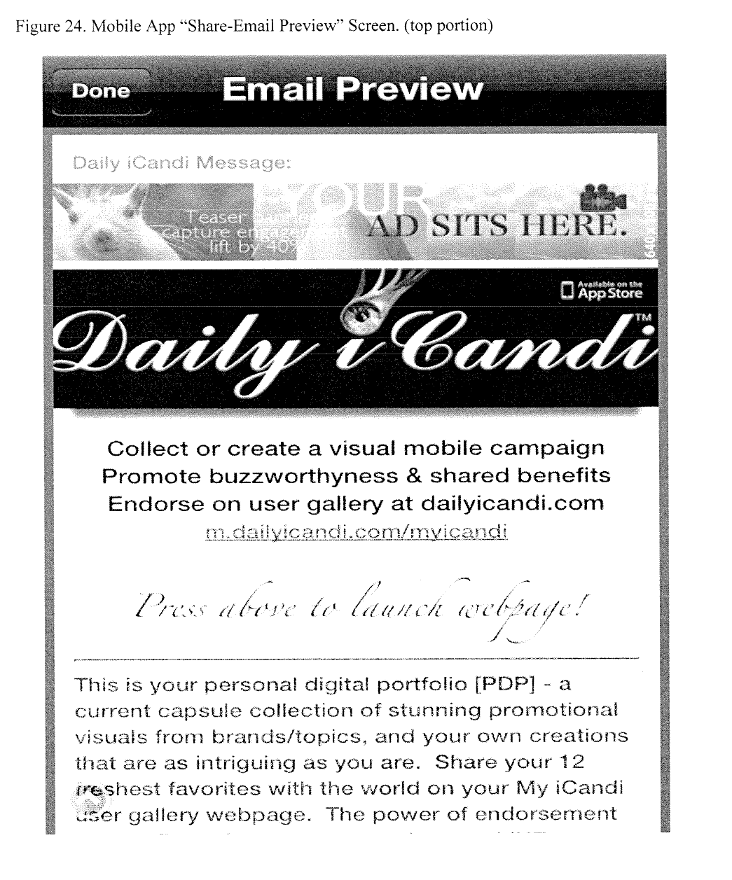

C6. “Content Unit” sharing via “Email Design” user-defined template interactive screen—(see FIG. 23) For any viewable “Content Unit” categorized by any topic, date, slide/unit #, a user may decide to share it via email, and customize the appearance by defining their own Masthead image file URL and corresponding weblink URL to launch in a web browser when the Masthead image is clicked. In addition, the user may optionally supply usernames for other social media services to create designated user account URL links to launch in web browser when social media buttons appear in the HTML email generated from this template designer. If the user is a registered user on the mobile-optimized website, and has entered their username and password information in the app's Settings-Send to My iCandi Webpage screen, then their currently active banner which they may have sent from the app to the mobile site will appear in one of several banner positions within the email template, determined by the “Banner Position” numerical value. The email template border thickness and color can be set, if the “Border Color” switch is set to the Border setting, via the “Border Size” value and Red/Green/Blue color sliders. If the “Border Color” switch is set to Interior, then the Red/Green/Blue color sliders define the interior email background color behind the text and other objects inside the border of the email template. You can press the “Preview” button to preview the email appearance for the current Email Design settings (see FIGS. 24 & 25).

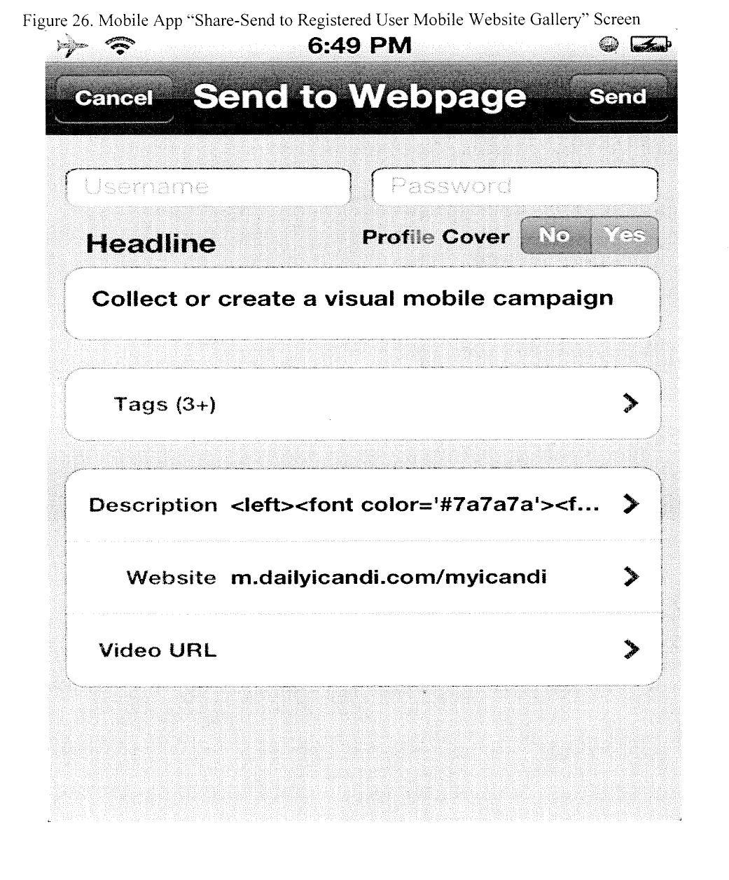

C7. Sending “Content Unit” to their registered user mobile website social gallery page—(see FIG. 26) For any viewable “Content Unit” categorized by any topic, date, slide/unit #, a user may decide to send it to their registered user mobile website social gallery page on servers controlled by the app platform operator. If the user has entered their mobile website registered user username and password information in the app's Settings-Send to My iCandi Webpage screen, it will appear in the text fields on the “Send to Webpage” screen. The user can change the values in the Username and Password text fields, modify the Headline and Description (HTML webpage text syntax) that will appear on their flip/hover display text area appearing behind the sent “Image unit” in their mobile web gallery userpage/slideshow/grid gallery displays, as well as the website URL and video URL text fields for buttons on the flip/hover display, and keyword tags to associate with the “Content Unit”.

When the user hits the “Send” button, if an Internet connection is active, the app sends this data to the registered user's account on the app platform operator's servers. Thereafter, the user may check their mobile website userpage gallery auto-slideshow or grid layout to view the “content unit” that they sent. On the main “Share” app screen, the user can press the yellow “My iCandi (heart logo)” button to launch an in-app web browser to view their registered user mobile web userpage gallery.

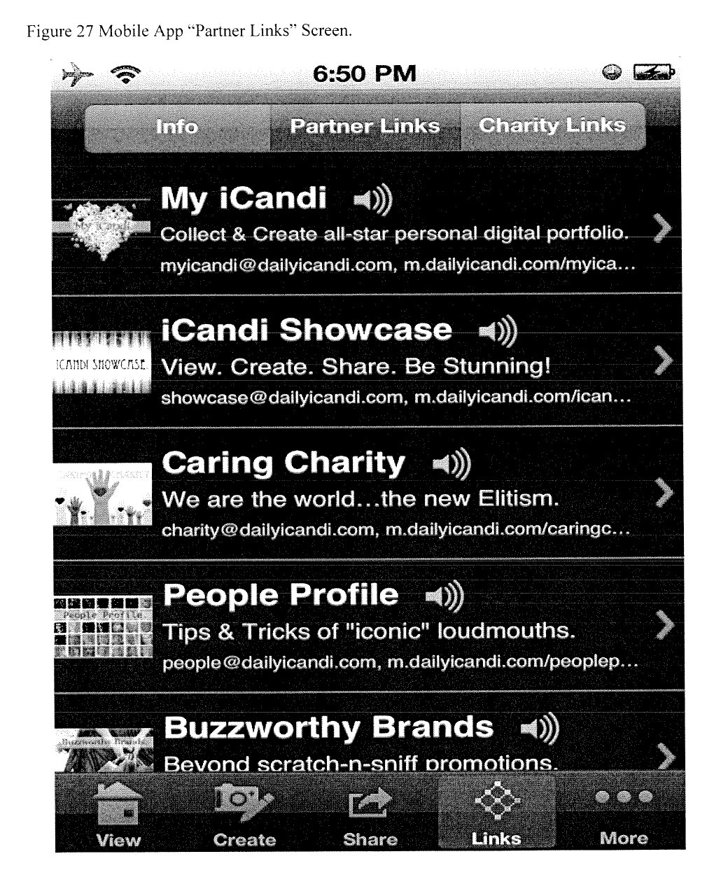

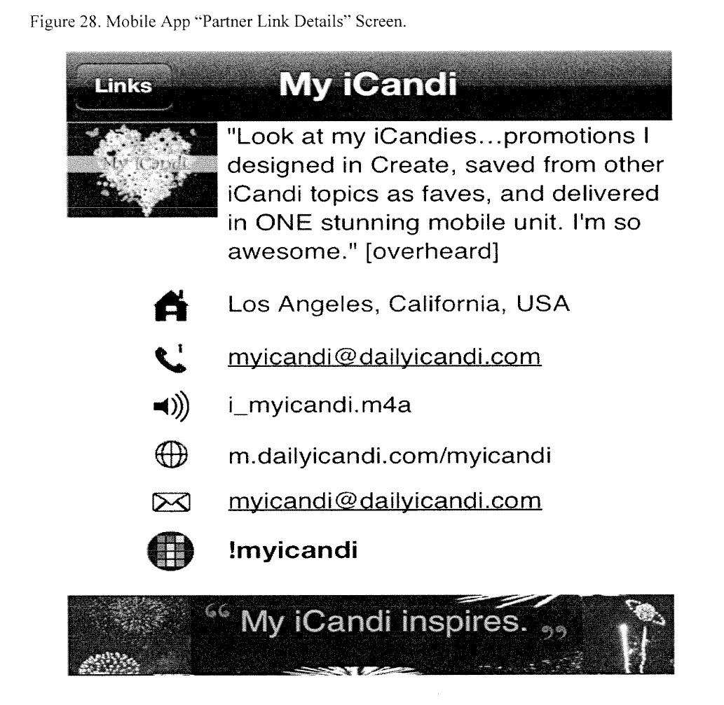

C8. Partner Links & Detail screens associated with “Content Unit” for topic/date/slide #—For any viewable “Content Unit” categorized by any topic, date, slide/unit #, a user may view a table listing of multiple associated topic/brand/user information entries (see FIG. 27). Each entry thumbnail may include a rectangular or square avatar image link to the partner's mobile website user gallery page, the partner link name, a catchy tagline, and link contact information (such as phone number, email address, website, etc.), and an optional audio playback/stop button to play an audio introduction. Certain link entries may be designated as special “Charity”-affiliated links, which will exclusively show up when the user presses the “Charity Links” switch setting. If the user presses on any individual partner link, a detailed partner link screen (see FIG. 28) appears to show the rectangular or square avatar image link to the partner's mobile website user gallery page, a catchy introduction text paragraph, address, primary contact information (phone number), either secondary contact information or an audio file path/URL, main webpage, email address, and either their mobile website social content gallery registered username or separate fax number. Most of the contact information and buttons are active user objects which will launch new screens such as partial screen map displays, mobile phone dialing, email entry interface, audio playback/stop, and in-app web browsers to the main link webpage and to our various webpages (auto-slideshow/grid gallery/user profile, and others) in our mobile-optimized social website gallery, that display different users' favorite recent “Content Units” sent from their app on their mobile device.

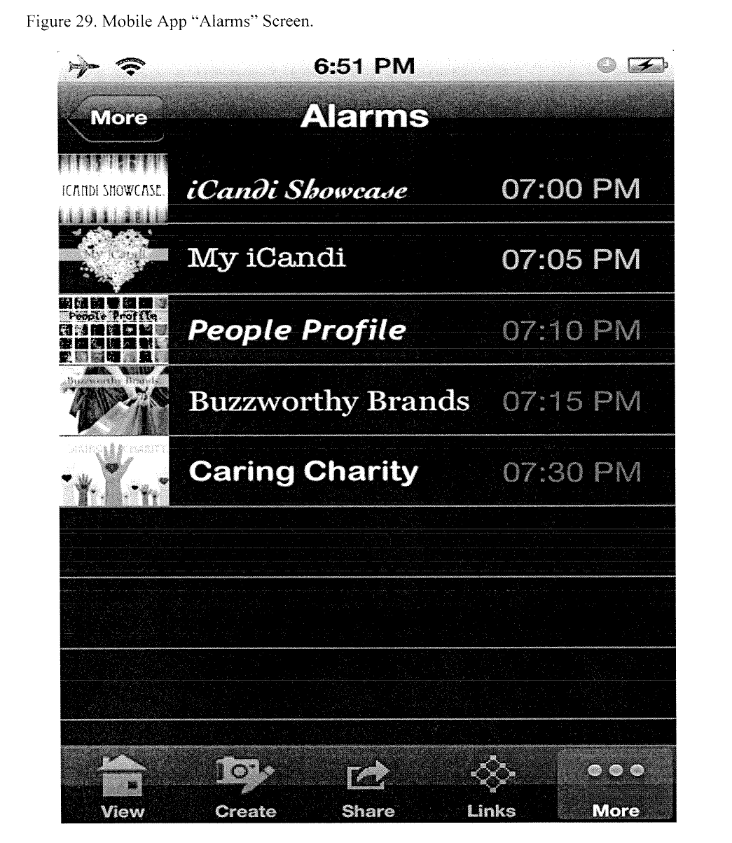

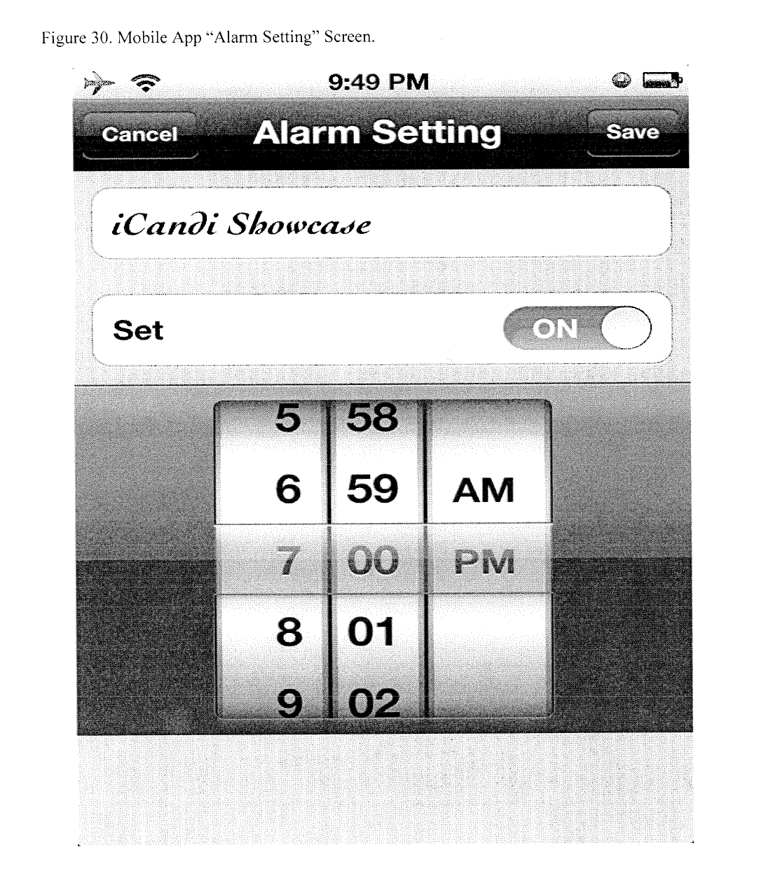

C9. Alarms Topic Notification screen to enable/disable/set daily time for each topic alarm—(see FIG. 29) This screen displays a table listing the topic image avatars, topic names, and current topic daily notification times with color-coding to reflect whether the alarm is enabled (green) or disable (red) for the current topics in the app on the user's mobile device. By pressing a specific topic in the table, a user views the “Alarm Setting” screen (see FIG. 30) to select whether to enable or disable, and set the time for, the daily topic alert alarm, which will display special topic-related information for the current day as a banner or dialog notification on the mobile device screen. If the notification is pressed, the mobile app may appear/launch (if it is closed or in the background (not the active app)), and potentially jump to display that specific topic's initial slide for today. The mobile app may also provide a means for the user to set their own custom daily notifications for their “My iCandi” topic for the day of any month, or specific days of the year.

C10. Topic Updates screen to manually check for new topic content on the app platform operator's server—(see FIG. 31) This screen displays a table listing of the topic image avatar images and topic names. Similar to the automatic topic updating, which is performed (if an internet connection is active) for each selected topic displayed in the user's topic list (shown on the “View” screen), if a user presses a specific topic in this “Updates” table, the app communicates to a topic server to download and check an UPDATES instruction text definition file for any new update instructions, and, if there are new updates, to download text definition files with 1 or more update modifications or additions to perform on selected client database records for that topic, and to download associated media/image file assets to store in that topic's defined directory for the app on the client mobile device. The changes to the client database appear on the app's “View” screen “Content Units”, which are selected using various topic, date (year, month, day), and slide/unit # combinations, or viewed for a specific day in an optional slideshow display. Additionally, if a user wants to ensure all the current VIP topic updates are present on their mobile device, the user can press the “Reset” button, followed by the VIP topic for which to reset the “last update date information”, then the next VIP topic update will ensure the most current VIP topic information.

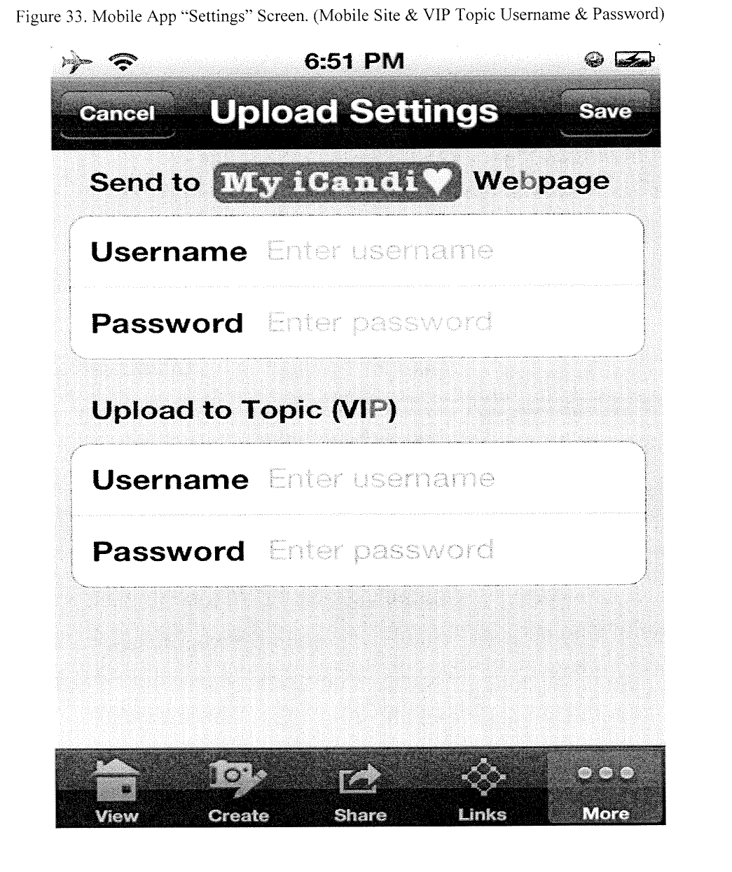

C11. Upload Settings screen for users to store their mobile website registered username and password, and for VIP partners (given their own topic by the app platform operator) to enter their topic server username and password—(see FIG. 33) This screen allows all users to enter and save their mobile website social user gallery (“My iCandi” username and password, so that the other app screens, such as the “View” screen for their “My iCandi” topic image links to launch their mobile site “content unit” gallery in an in-app browser, as well as the “Create” screen for sending their avatars and/or banners to their mobile site user profile, and finally the “Share” screen for customization of their email template for “content unit” communication, for social media links back to their mobile site gallery, and for the authorization of the direct transmission path of sending “content units” to their “My iCandi” mobile webpage account (for display via auto-slideshow and grid gallery).

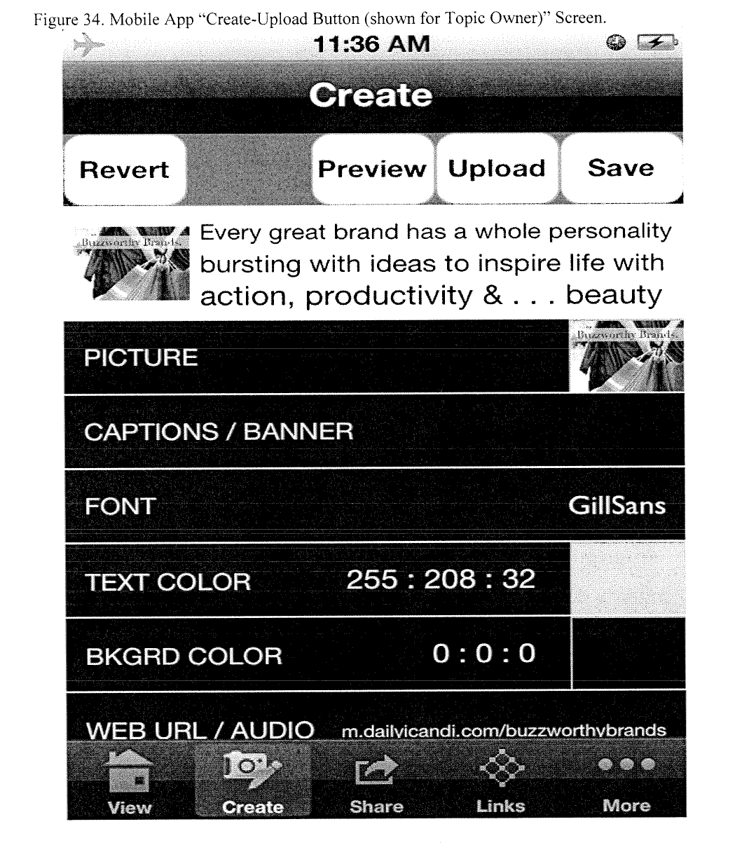

The second set of username and password text fields, Upload to Topic (VIP), allow VIP partners who have been granted, by the app platform operator, their own app topic for either automatic presence in all app users' topic lists or available presence via manual selection from the topic catalog. VIP partners, who have entered their topic username and valid password, can use the “Create” screen's “Upload” button (see FIG. 34) to upload their “Content Unit” creations directly to their authorized topic area/directory on the app platform operator's server. Thereafter, the “content unit” will be immediately available for download by all app users who have that VIP topic in their app's topic list (new content is downloaded upon the next refresh of that topic in the “View” screen or in the “Updates” screen).

D) Mobile App Client-Side Software Marketing Mechanisms, Configurations & Specifications

D0.1 Hardware presence—These app definitions apply to any software displayed and created on a mobile (battery-attached/onboard power source) hardware device which can be transported/move along with the movements taken by an individual person. This software will be displayed on the mobile device's visible display, which can also simultaneously project its output via wired/wireless/remote internet connection onto other physical display formats/technologies, with user input via any combination of the device's touchpanel screen (usually glass), audio/voice, physical/physiological movement, and any other user input which may occur from remote distances over the internet or other communication medium.

D0.2 Offline Operation/Topic “Content Unit” Local Storage on Mobile Device—Different from many other mobile social apps, this software does not require a constant online communications/Internet connection to operate. All content can be created independently on the device either originally (by taking photos or using personal images in the device's library, generating story text/HTML web pages directly, or selecting music on the device (currently Apple iPod/iTunes library)), or by repurposing/modifying aspects of collected “content units” from other topics present in the app software. The core content for other topics in the app resides in the local storage on the mobile device. When an online Internet connection is active, content for the user's topics in their topic list may be downloaded from the app platform operator's servers. These topic “Content Units” are indexed by date (year, month, day) and slide/unit #. Therefore, content covering many days (today, in the future, in the past), and pre-planned campaigns, will be downloaded to the app on users' mobile devices. This results in efficient internet data bandwidth and charges, and energy consumption, avoided repetitive continuous download of data, images, multimedia for the user's own content (in their “My iCandi” topic) and the content from their other selected preferred topics from VIP partners and the app platform operator. The internet connection is only required only needed to download any content specified via internet weblinks, to download any new content for a specific topic into the device, to download any newly selected topics' initial configuration and content information, or to share “content units” to others via email, other social media networks, or to the mobile-optimized website server owned by the app platform operator, and/or its selected partners. Therefore, users of the mobile app do not need to login via username and password entry to use most features of the software. This is primarily needed when accessing content from a registered user's webpage gallery contents in the app, or when sending and sharing new “content units” to the user's mobile website gallery.

Each topic in the app platform has a topic configuration table in the client database that can be updated (or pre-configured for pre-installed app topics) from a text definition file that is downloaded and updated during an app topic update operation.

The special client-side marketing mechanisms, configurations, and specifications implemented in this software are detailed below.

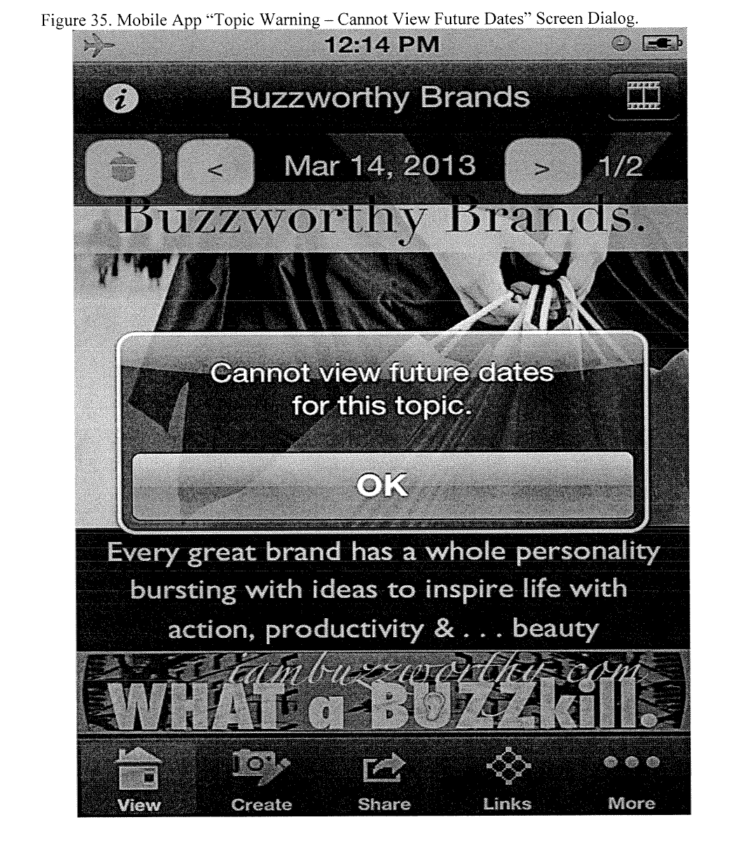

D1. Data access to topic content regulated by topic settings, such as not allowing “content unit” viewing for future dates—Each topic has a client database field which specifies whether or not to allow users to view “content units” for future dates. If a user tries to advance view a “content unit” for a topic which does not allow future viewing, a warning dialog message box will appear (see FIG. 35). This incentifies and encourages the user to check this app topic as often as every day to receive and view new “content units”. If the user has already setup daily topic alarm notifications to automatically launch the app topic at their preferred time of the day (“Alarms” screen), then each day, after pressing the notification, they will gain instant access to the “Content Units” in their mobile device already, and any newly downloaded units (if an Internet connection is present).

D2. User Repurposing of elements of other topics' “content units” (either to a copy moved to their “My iCandi” personal topic via the favorite button, or directly to the topic “content unit”, if permitted by the VIP topic owner in the topic database table setting)—Each topic has a client database field which specifies whether or not to allow users to create or modify “content units” stored in their VIP partner topic on the user's mobile device. If the VIP topic owner allows users to modify/repurpose “content units” and add new “content units” to organize them under their app topic, the strength of the brand connection between the user and the topic owner's brand may increase, and encourage sharing by the user to promote the brand. If the VIP topic owner does not allow users to modify/repurpose “content units” or add new “content units” under their app topic, users can save a copy of it to their private “My iCandi” topic via the favorite (“Acorn”) button on the “ghosted date/slide/favorite bar”. The copy of the “content unit” contains both the text definitions, image and multimedia files, including the associated sponsor banner defined for that topic's “content unit”. Thereafter, that banner will be available for selection in the user's My iCandi banner picker roll to accompany any of their own custom created “content units”.

After the “content unit” has been duplicated from the other topic to the user's “My iCandi” topic, via the “Create” screen tools, the user can freely repurpose/modify elements of their collected “content units” from other topics, and choose to share their repurposed creations. The user is responsible for ensuring that they have necessary licensing for any of their own generated content, and attribute proper credit to any content owned by others. Users may be able to add their own comments in the “content unit” HTML/text description, in the Share via Email message composer, and when sharing the “content unit” to their (“My iCandi”) registered user mobile website social user gallery, viewable by the public.

D3. Banner component operation, rotation & specifications, separate from the rest of the “Image Unit” portion of any “content unit”—“Content units” have the front side “Image Unit” which consists of the visible components, mentioned in section B of this document. Using the “Create” screen in the app, the banner portion of this “Image Unit” may be “repurposed” via custom selection of an available topic banner by the user, even for topics controlled by the app platform operator or by its VIP partner partners (at a minimum, the combined newly selected banner and the rest of the original “image unit” are viewable in the “Create-Preview” screen). These “repurposed” “Content Unit” front-side images are shareable as an composite image via email, other social media, to the mobile-device's photo library, and, optimally, to the registered user's mobile website userpage gallery.

Additionally, a key aspect to the “View” screen's display of “content units” involves the display of an initial “defined” banner image file that is stored with every “content unit” client database record. After displaying this defined banner image with the rest of the “Content Unit”, other corresponding banners related to the initial defined banner will display in circular repetitive rotation, which may be optionally mixed with banners from external ad networks (if an Internet connection is active). Therefore, an integrated banner campaign can be defined for use with specific “content units”, with the added benefit of these campaigns being selectable by the user. For topics other than the (“My iCandi”) private user topic, the initial defined banner will be displayed, then any other banner image files, with filenames that contain the same filename prefix of the initial defined banner, will be sorted into a banner rotation for display. For the (“My iCandi”) user topic, the entire set of topic banners, which may include banners from other topics which w ere copied over with favorited “Content Units”, will be rotated for display, starting from the initial defined banner. Banners may have a show/hide display button for user control, especially in landscape orientation. Banners may either play audio or launch in-app web browsers to the associated banner URL. If banner audio is playing, an AV button for silencing/stopping audio allows for user control.

Another key aspect to the “View” screen's display of “content units” involves the display of the marquee ticker portion of the banner's initial “defined” marquee file that is stored with every “content unit” client database record. In the app, for a specific slide, defined by topic, date, and slide number, a unique marquee ticker file can optionally be defined to be accessed/read/processed to display a marquee vertical scrolling of HTML-formatted text to inform topic/user/personalized information, and a horizontally scrolling display of multiple avatar images in rotating grouped sets. The avatar images can optionally be single-clicked to launch an associated webpage, or can optionally be double-clicked to refresh the entire marquee ticker text and avatar image sets, in round-robin fashion, for the specific My iCandi username defined for that avatar, by accessing the ticker file located on the app platform's web server.

Using the “Create” screen in the app, the marquee ticker portion of the banner area may be “repurposed” via custom selection of any available My iCandi marquee ticker-formatted file on the public Internet. The marquee ticket-formatted file may include that on the My iCandi app platform web server denoted by a shortcut reference to any available My iCandi username (or (!)promoted username).

D4. Offline Native Mobile Device Collection of User Engagement Statistics involving Specific Topics via Alarm Notification Viewing and other User Interface actions—Even without an internet connection, the mobile app can record user engagement actions, such as pressing a topic alarm notification for certain days of the month, and translate those actions according to point value scoring system, which may or may not be specific to that topic. These accumulated scores over a period of time may be transmitted or displayed to the app platform operator and/or its affiliates. VIP topic partners, and/or directly to the user. Parties receiving this scoring data may analyze the data, and offer special rewards or benefits to individual users, to the entire set or subset of topic viewers, or based on other criteria.

D5. “Default Month” Designation for “Content Units” in Client Database & Text Definition Files—Usually, every “Content Unit” is defined by its Topic, Date (Year/Month/Day), and Slide/Unit #. This app platform contains a special feature to allow topic operators the ability to define “Content Units” with a “Default Month” whose value is Zero (0) in the mobile device client database and text definition files. If the user selects a date for which there is no exactly defined slide for that specific date, then the Day value will be matched to the “Default Month” (0), such that those defined slides will be displayable to the user in the “View” screen. This is a great advantage for the VIP partner topic creators, because 1) they can avoid unnecessary burden of creating at least 1 different “Content Unit” for every day of the year by relying on creating at least 1 different “Default Month” slide (total 31) for each possible day of any month, 2) they retain user engagement by not having any blank “No Content” days, 3) they can create a “special month” generic, non-date specific, but ordered, brand-strengthening slideshow summary of their core differentiating mission/advantages/values, featuring structured, organized data with interactive multimedia and web content, with partner links and endorsement banners.

E) Mobile-Optimized Website Social User Gallery of App-Collected/Created “Content Units”

E0.1 Hardware presence/Internet connection—Because the mobile-optimized website social user gallery is viewable in any web browser with an active Internet connection, the software can be displayed on any hardware device which can display a modern web browser capable of HTML5, Javascript, PHP, and other technologies generally available after year 2012.

E0.2 Mobile website registered user login—This software may display some public content to users without them needing to login via username and password entry, which is required to use certain features of the website social gallery (favorite voting, link requests/acceptances/denials, navigation to your userpage).

The key functional mobile-optimized website social user gallery features are detailed below.

E1. A registered user's mobile website social user gallery receives both “content units” for the auto-slideshow and grid galleries, and avatar images and banners for the user profile page, sent from the mobile app software—Users of the mobile application software can send any “content unit” under any topic to their registered user mobile-optimized website gallery running on the app platform operator's server for public viewing of advanced features of the “content unit” (detailed active HTML element description, clickable image banner ad links, hoverable display features, auto slideshow display movement, grid gallery navigation, remote mobile app topic and feature launch, and sharing via email and to social networks).

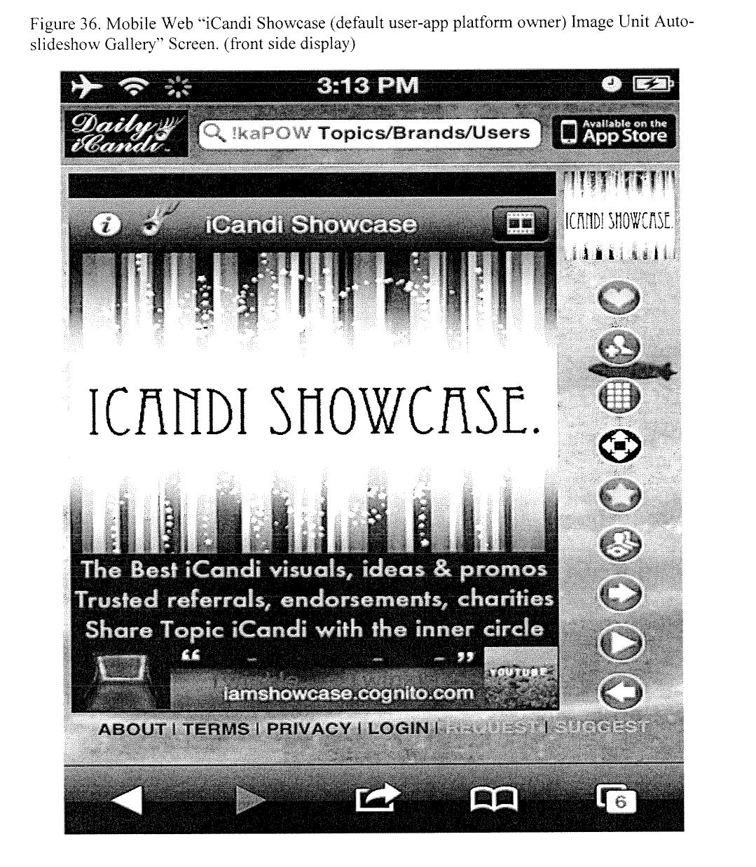

E2. Mobile website launches into the main “Showcase” topic controlled by the app/mobile web server platform operator, in auto-slideshow gallery mode to display rotating “content units” previously sent from app—(see FIG. 36) The image portion (topic navigation bar, (optional) date/slide/favorite selector bar, image, stylized caption, banner, (optional) superimposed AV button) of the initial “content unit” sent previously from the mobile application is displayed, then subsequent image portions of “content units” will rotate into the main display. The banner portion of the “content unit” is clickable to launch the defined banner weblink URL in a separate browser window. To navigate this registered topic/user's “content slides”, the user may left or right swipe, mouse click-drag, or forward or reverse arrow button, to manually move the “content units” ahead or back. The slideshow can be paused or resumed via the pause/play button. There is a full screen button to view the “content unit” in full screen. If the user has logged in, then the jump to my user gallery (“My iCandi”), favorite, and link request buttons are operational.

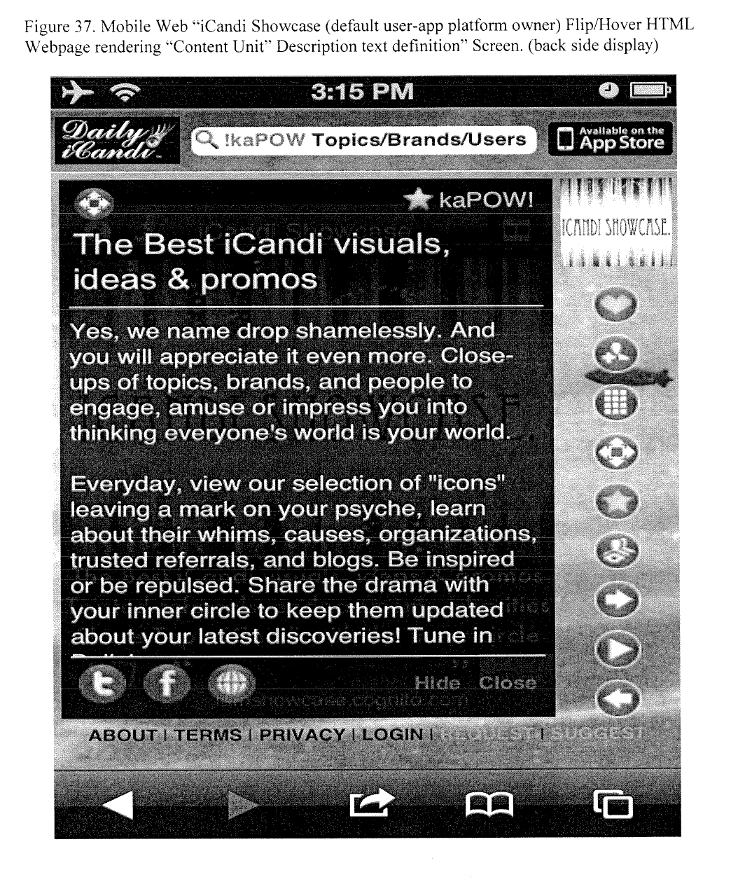

E3. Extra (3^{rd}) Dimension user inter ace hover/flip HTML webpage browser screen—(see FIGS. 37 & 44) Press anywhere on the Image or 3-line caption area, above the banner, to display the hover/flip HTML webpage browser that renders the “content unit” description, which can be swiped to scroll up and down in most modern browsers. There may be any combination of full screen, favorite, main weblink URL, video URL, social media, and email buttons in the header and footer bars. The displayed headline caption is an active weblink to launch a weblink URL in a new browser window. To return back to the front image portion of the “content unit”, press or hover over either the “Hide” red text in the footer bar of the HTML description (to return to a static paused slideshow), or the “Close” red text in that bar (to return to an actively rotating slideshow).

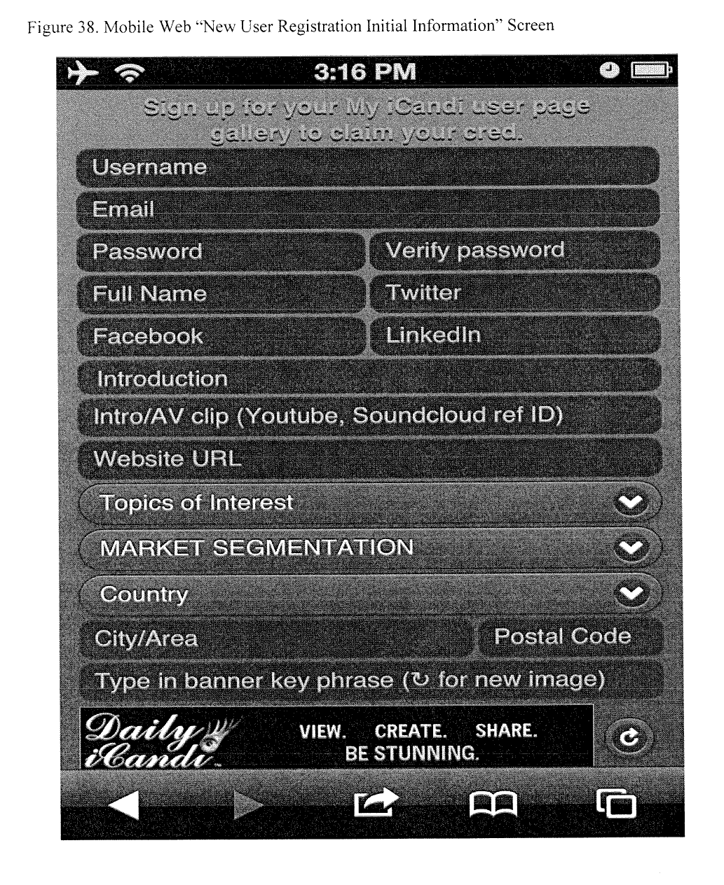

E4. New User Signup Registration—(sec FIG. 38) When a website visitor, hits a Signup button, multiple forms may appear to request information such as their desired username (which will be prefixed with an ! (exclamation point)), email address for communication, password, full name, social media username, introductory paragraph (to show up on their avatar intro dialog), any introductory audio/video media ID, main website URL, topics of interest, market segmentation age group, country, city, area/postal code, and potentially answers to required/optional profile questions, all verified by a “Type-in” banner phrase match request.

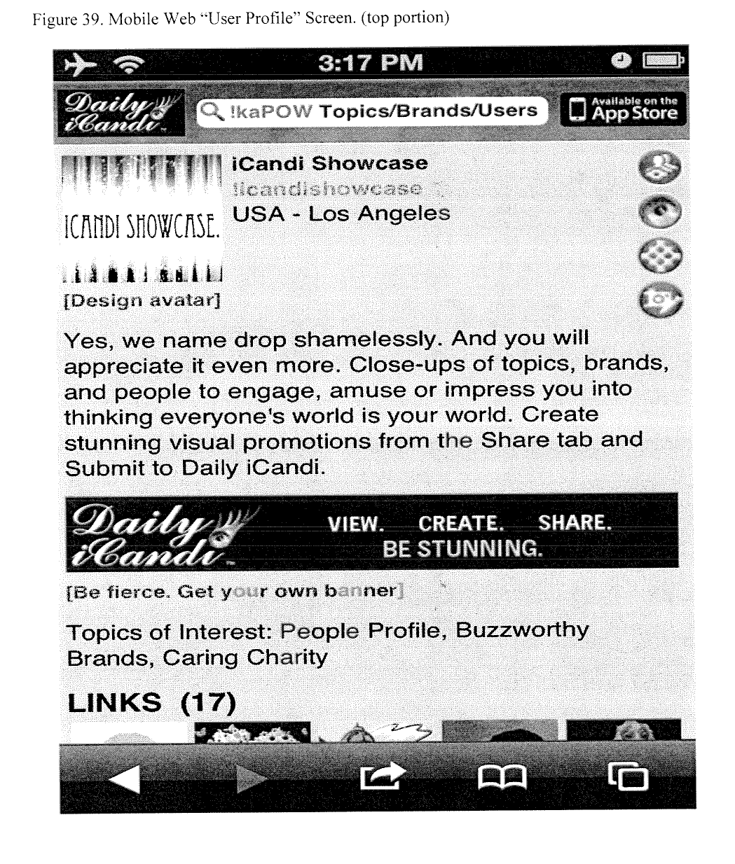

E5. User Profile Screen—(see FIGS. 39 & 40) Website visitors can view their own user profile page or any other brand/topic/user profile page (by typing the main mobile website URL, backslash, the username, and ‘#profile’, ex. ‘myicandi#profile’), or by navigating to other linked avatars on profile or search pages). The profile page allows you to link to the user (if you are logged in), view their favorite mobile app-collected/created banners sent to the mobile site (and press them to launch their weblink URLs in browser windows), read user profile introductions and other information, and learn about their 2-way trusted user links & link requests to and from other users. In addition, if the mobile site is being viewed on a mobile device that has the mobile application software installed, there are buttons to launch the app, jump to the Partner Links/Create/Create Banner/Create Banner—Select Image (Avatar) app screens.

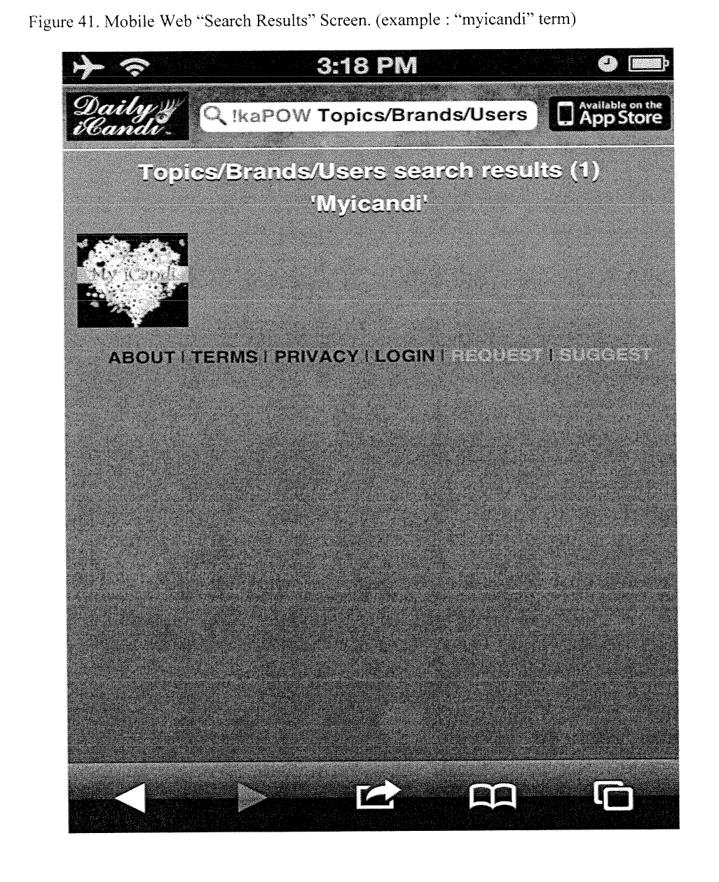

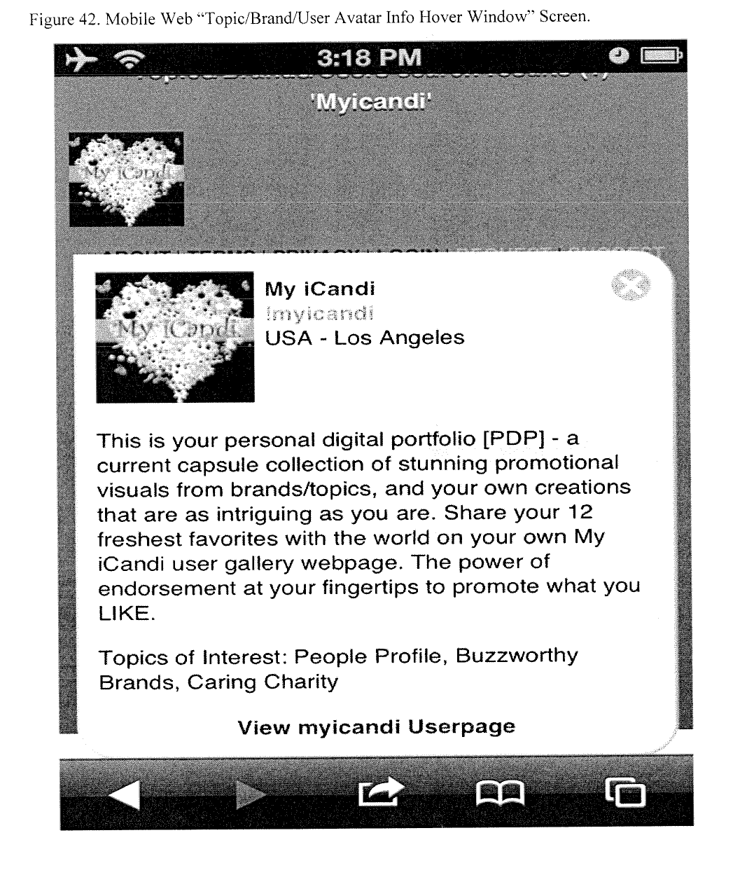

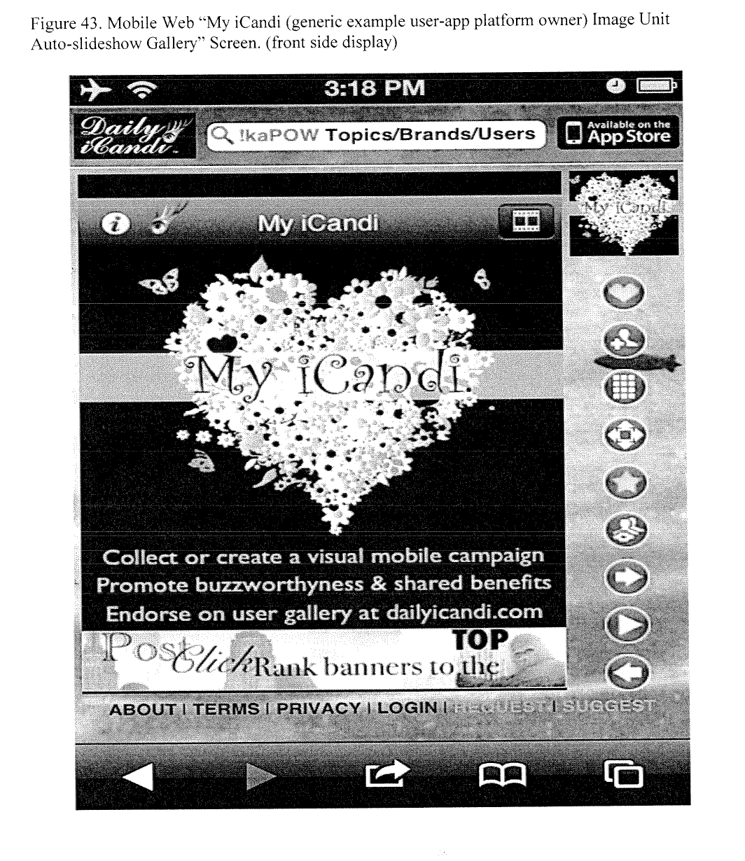

E6. Search Bar in Prominent Top Center position of mobile-optimized website—(see FIG. 41) In the top center text entry box, website visitors can enter search queries for usernames, other phrases in user profiles, or other mobile site content on any other brand/topic/user profile page. The matching topic/brand/user avatars are displayed in grid table format. The user can press/hover over any avatar (see FIG. 42) to view its user introduction, then decide whether to launch the user's auto-slideshow (see FIGS. 43 & 44), profile, or other information page.

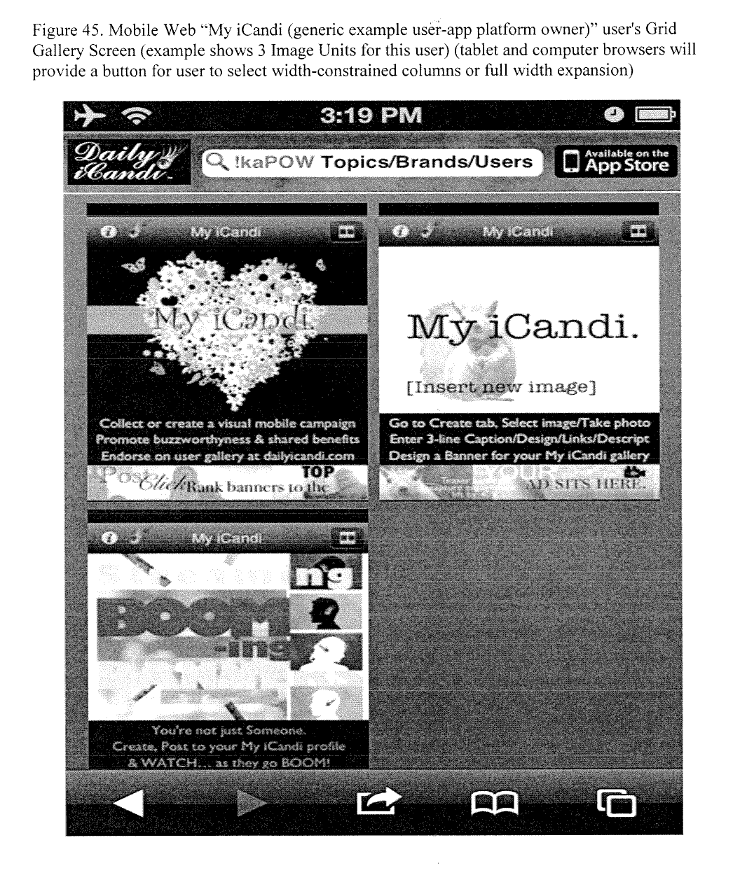

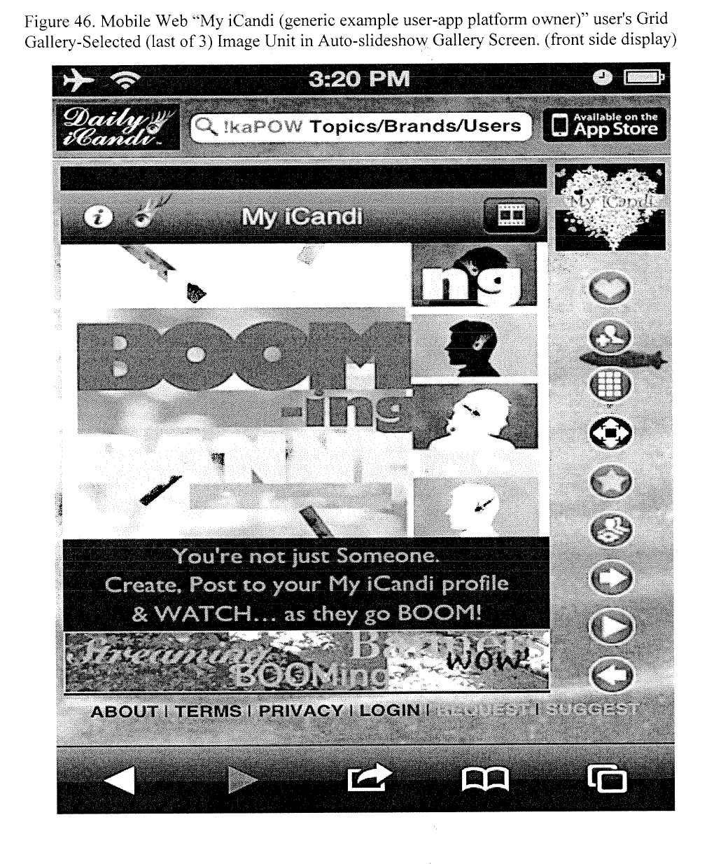

E7. Interactive Gallery Grid Layout Display—(see FIG. 45) When viewing a user's auto-slideshow gallery, you can press the “grid” (12 squares in row/column) button to launch the user's Grid Gallery Screen, which will display all of the user's “content units” in row/column format. You are able to click the banners to launch web browsers to show the banner weblink URL pages, and may be able to press on/hover over the image/caption area to invoke the flip/hover operation to view and edit the “content unit”'s HTML web browser description summary. On tablet and computer browsers, there is a button for the user to select width-constrained columns or full width expansion display of the “content units”. If you select one of the “content units” in the Grid Gallery, that “content unit” will be displayed in the auto-slideshow Gallery Screen. (see FIG. 46, front side display)

We claim:

1. A method for creating digital media content on a computing device, comprising:
displaying an image unit of a selected topic on the computing device, wherein the image unit contains digital media content and wherein the image unit corresponds to a content unit containing a description of the digital media content;
providing one or more controls to allow interactive manipulation of the digital media content, wherein the manipulation of the digital media content modifies the description of the digital media content in the content unit;
interactively playing back the image unit to reflect the manipulation of the digital media content; and
publishing the content unit to allow viewing of the digital media content of the image unit.

2. The method of claim 1, wherein the description of the digital media content in the content unit is written in Hyper Text Markup Language (HTML), and wherein the controls further allow modification of the HTML description to be interactively reflected in the playing back of the image unit.

3. The method of claim 1, wherein the image unit includes a topic navigation bar, an image, a text captioned line area, and a banner.

4. The method of claim 3, wherein the banner comprises a plurality of banners that are cyclically rotated into view during said displaying of the image unit.

5. The method of claim 3, wherein the image unit further includes an icon representing a uniform resource locator (URL) link.

6. The method of claim 5, wherein when the icon is selected, further comprising launching a window to invoke content referenced by the URL.

7. The method of claim 1, wherein when a predefined area of the image unit is selected, further comprising replacing said displaying of the image unit with a display of the content unit corresponding to the image unit.

8. The method of claim 5, wherein said providing one or more controls to allow interactive manipulation of the digital media content comprises providing the controls for customizing the image, the text captioned area, the banner, and the URL link.

9. The method of claim 5, wherein said providing one or more controls to allow interactive manipulation of the digital media content comprises providing the controls for creating the image, the text captioned area, the banner, and the URL link.

10. The method of claim 1, wherein said publishing comprises capturing the content unit corresponding to the image unit and sending the content unit and the image unit to a server.

11. The method of claim 1, wherein said publishing comprises emailing the content unit and the digital media content of the image unit corresponding to the content unit in a customizable email.

12. The method of claim 1, further comprising displaying a listing of entries that are associated with the selected topic of the displaying image unit, wherein the entries belong to one or more partners and are selectable for linking to the digital media content of the image unit corresponding to the content unit published by the partner of the selected entry.

13. The method of claim 1, further comprising locally storing on the computing device the image units of a plurality of topics, and for displaying the locally stored image units.

14. The method of claim 13, further comprising updating the image units of the plurality of topics from a server.

15. An apparatus to create digital media content, comprising:
a display screen;
one or more memories configured to store machine readable instructions; and
a processor configured to execute the machine readable instructions to:
display on the display screen an image unit of a selected topic, wherein the image unit contains digital media content and wherein the image unit corresponds to a content unit containing a description of the digital media content;
provide one or more controls to allow interactive manipulation of the digital media content, wherein the manipulation of the digital media content modifies the description of the digital media content in the content unit;
interactively play back the image unit to reflect the manipulation of the digital media content; and
publish the content unit to allow public viewing of the digital media content of the image unit.

16. The apparatus of claim 15, wherein the description of the digital media content in the content unit is written in Hyper Text Markup Language (HTML), and wherein the controls further allow modification of the HTML description to be interactively reflected in the play back of the image unit.

17. The apparatus of claim 15, wherein the image unit includes a topic navigation bar, an image, a text captioned line area, a banner, and an icon that represents a uniform resource locator (URL) link.

18. The apparatus of claim 15, wherein when a predefined area of the image unit is selected, the processor is further configured to replace the display of the image unit with a display of the content unit corresponding to the image unit.

19. The apparatus of claim 17, wherein the processor is configured to provide one or more controls to allow interactive manipulation of the digital media content by being further configured to provide the controls to customize or edit the image, the text captioned area, the banner, and the URL link.

20. The apparatus of claim 15, wherein the processor is configured to publish the content unit by being further configured to capture the content unit corresponding to the image unit, and to send the content unit and the image unit to a server.

21. A method for delivering digital media content from a computing device, comprising:
displaying an image unit of a topic selected from a plurality of topics stored on the computing device, wherein the image unit contains digital media content and wherein the image unit corresponds to a content unit containing a description of the digital media content;
providing controls for flipping between said displaying of the image unit and displaying the content unit corresponding to the image unit; and
providing one or more icons representing uniform resource locator (URL) links for launching linked image contents referenced by the URL links.

22. The method of claim 21, wherein the description of the digital media content in the content unit is written in Hyper Text Markup Language (HTML).

23. The method of claim 21, wherein the image unit includes a topic navigation bar, an image, a text captioned line area, and a banner.

24. The method of claim 23, wherein the banner represents a banner URL link, and wherein when the banner is selected, the method further comprises launching content referenced by the banner URL link.

25. The method of claim 21, wherein said displaying an image unit comprises rotating through a plurality of image units in a slide show mode.

26. The method of claim 21, wherein said displaying an image unit comprises displaying a plurality of image units in a row and column grid format.

27. The method of claim 21, wherein the image unit and the content unit corresponding to the image unit are uploaded from a mobile device, wherein the image unit and the content unit belong to a user's account.

28. The method of claim 21, further comprising accepting search queries for displaying one or more image units whose description of the digital media content matches the search queries.

29. An apparatus to deliver digital media content, comprising:
one or more memories configured to store machine readable instructions; and
a processor configured to execute the machine readable instructions to:
display on a display screen an image unit of a topic selected from a plurality of topics stored on the apparatus, wherein the image unit contains digital media content and wherein the image unit corresponds to a content unit containing a description of the digital media content;
provide controls to flip between the display of the image unit and a display of the content unit corresponding to the image unit; and
provide one or more icons that represent uniform resource locator (URL) links to launching linked image contents referenced by the URL links.

30. The apparatus of claim 29, wherein the description of the digital media content in the content unit is written in Hyper Text Markup Language (HTML).

31. The apparatus of claim 29, wherein the image unit includes a topic navigation bar, an image, a text captioned line area, and a banner.

32. The apparatus of claim 29, wherein the processor is configured to display the image unit by being further configured to rotate through a plurality of image units in a slide show mode.

33. The apparatus of claim 29, wherein the processor is configured to display the image unit by being further configured to display a plurality of image units in a row and column grid format.
